(19) United States
(12) Patent Application Publication
(10) Pub. No.: US 2004/0208177 A1
(43) Pub. Date: Oct. 21, 2004

(54) Semiconductor circuit device, packet processing method, management system, management method and packet processing method

(76) Inventor: Tetsuo Ogawa, Tokyo (JP)

Correspondence Address: J.C. PATENTS, SUITE 250, 4 VENTURE, IRVINE, CA, 92618, US

(21) Appl. No.: 10/839,411

(22) Filed: May 4, 2004

Related U.S. Application Data
(63) Continuation of application No. PCT/JP02/08958, filed on Sep. 3, 2002.

(30) Foreign Application Priority Data
Jul. 1, 2002 (JP) 2002-192549
Jul. 1, 2002 (JP) 2002-192550
Jul. 11, 2002 (JP) 2002-203258
Jul. 11, 2002 (JP) 2002-203259
Jul. 11, 2002 (JP) 2002-203260

(51) Int. Cl. H04L 12/56

(52) U.S. Cl. 370/392; 370/412

(57) ABSTRACT

A semiconductor circuit device connected to a communication network includes: the first receive buffer for storing a packet received from the communication network; the first processing circuit for performing the first processing based on the first partial data that is a part of the packet stored in the first receive buffer; the second receive buffer for receiving the second partial data of the packet stored in the first receive buffer from the first receive buffer and storing the second partial data, the second partial data being different from the first partial data; and the second processing circuit for performing the second processing that requires a longer processing time than the first processing, based on the second partial data stored in the second receive buffer.

### CROSS-REFERENCE TO RELATED APPLICATION

The present application is a continuation application of PCT/JP2002/008958 filed on Sep. 3, 2002, which claims priority from Japanese Patent Applications Nos. 2002-192549 filed on Jul. 1, 2002, 2002-192550 filed on Jul. 1, 2002, 2002-203258 filed on Jul. 11, 2002, 2002-203259 filed on Jul. 11, 2002, and 2002-203260 filed on Jul. 11, 2002, the entire contents of which are incorporated herein by reference.

### BACKGROUND OF THE INVENTION

1. Technical Field

The present invention relates to a semiconductor circuit device, a packet processing method, a management system, a management method and a packet processing method. More particularly, the present invention relates to a semiconductor circuit device that is connected to a communication network.

2. Related Art

A method (proxy agent) has been conventionally known in which a workstation or the like, that has an SNMP (Simple Network Management Protocol) communication function, is connected to a device to be managed (managed object) that does not have an IP network connection function so as to manage the device to be managed. In this case, the workstation receives an SNMP message from a network management station via a communication network and manages the device to be managed in accordance with the received SNMP message.

However, the workstation is large in size and expensive, and requires much power. Thus, the conventional method described above, i.e., the proxy agent has a problem that an environment where it can be used is limited.

### SUMMARY OF THE INVENTION

Therefore, it is an object of the present invention to provide a semiconductor circuit device and a packet processing method which are capable of overcoming the above drawbacks accompanying the conventional art. The above object can be achieved by combinations described in the independent claims. The dependent claims define further advantageous and exemplary combinations of the present invention.

In order to achieve the above object, according to the first aspect of the present invention, a semiconductor circuit device that is connected to a communication network, comprises: a first receive buffer operable to store a packet received from said communication network; a first processing circuit operable to perform first processing based on first partial data that is a part of said packet stored in said first receive buffer; a second receive buffer operable to receive and store second partial data that is a part of said packet stored in said first receive buffer in parallel with said first processing at least partially, said second partial data being different from said first partial data; and a second processing circuit operable to perform second processing based on said second partial data stored in said second receive buffer, said second processing requiring a longer processing time than said first processing.

The semiconductor circuit device may further comprise a transfer circuit operable to transfer said second partial data from said first receive buffer to said second receive buffer, wherein the first processing circuit performs said first processing after said transfer circuit started to transfer said second partial data. The first receive buffer may store a packet header and packet data of said packet; the second receive buffer may store said packet data as second partial data; the first processing circuit may perform said first processing based on said packet header, and the second processing circuit may perform said second processing based on said packet data.

The packet header may contain an IP header and a transport header that is a header in a transport layer, and said first processing circuit may perform IP protocol processing and transport protocol processing based on said IP header and said transport header. The second receive buffer may be a ring buffer.

The semiconductor circuit device may further comprise: a window-size determination circuit operable to determine a window size in TCP based on an available capacity of said second receive buffer in a case where said packet is a packet based on TCP; and a window-size notification circuit operable to notify a sender of said packet of said window size. The second receive buffer may store said second partial data before said first receive buffer receives another packet next to said packet. The semiconductor circuit device may further comprise a transfer-unit notification circuit operable to notify a sender of said packet of a capacity of said first receive buffer as a maximum transfer unit when said first receive buffer received said packet having data amount larger than said capacity of said first receive buffer.

According to the second aspect of the present invention, a packet processing method for processing a packet received from a communication network, comprises: a first storing step of storing said received packet in a first receive buffer; a first processing step of performing first processing based on first partial data that is a part of said packet stored in said first receive buffer; a second storing step of transferring second partial data of said packet stored in said first receive buffer to a second receive buffer and storing said second partial data in said second receive buffer, at least partially in parallel with said first processing, said second partial data being different from said first partial data; and a second processing step of performing second processing based on said second partial data stored in said second receive buffer, said second processing requiring a longer processing time than said first processing.

According to the third aspect of the present invention, a semiconductor circuit device that is connected to a communication network, comprises: an input unit operable to input an external input signal from a device to be managed outside said semiconductor circuit device; an MIB storage unit operable to store input data indicating said external input signal input from said input unit in such a manner that said input data corresponds to an MIB (Management Information Base) object in SNMP (Simple Network Management Protocol); and an SNMP control unit operable to transmit said input data that was made to correspond to said MIB object, to said communication network by using a message based on SNMP. The SNMP control unit may manage an MIB object used for receiving a command for controlling said device to be managed from said communication network, and a command output unit may be further provided operable to, when said SNMP control unit received an SNMP message containing said command for said device to be managed from said communication network, give a command specified by said SNMP message to said device to be managed.

In a case where the SNMP control unit received an SNMP message instructing said SNMP control unit to transmit a command for outputting said external input signal to said device to be managed, said command output unit may give said command to said device to be managed, the MIB storage unit may store said external input signal output in response to said command, as said input data, and the SNMP control unit may transmit said input data to said communication network by using a message based on SNMP. The MIB storage unit may store said input data in such a manner that said input data corresponds to an input-data MIB object that does not depend on a type of said device to be managed, and may store said command in such a manner that said command corresponds to a command MIB object that does not depend on said type of said device to be managed, the SNMP control unit may transmit said input data corresponding to said input-data MIB object to said communication network, and the command output unit may give said command corresponding to said command MIB object to said device to be managed.

The external input signal may be an analog signal, and an AD converter may be further provided operable to generate said input data to be stored in said MIB storage unit by converting said analog signal into a digital signal. The MIB storage unit may have an averaging time interval storage unit operable to store a time interval at which an average of a value of said external input signal is calculated in such a manner that said time interval corresponds to an MIB object, and an average generation unit may be further provided for generating said input data by calculating said average of said value of said external input signal at said time interval set in said averaging time interval storage unit. When receiving an SNMP message instructing said SNMP control unit to set said averaging time interval storage unit from said communication network, said SNMP control unit may set said time interval specified by said SNMP message in said averaging time interval storage unit.

The MIB storage unit may have an input period storage unit operable to store a period with which a value of said external input signal is input in such a manner that said period corresponds to an MIB object, and a data-storage control unit may be further provided operable to make said MIB storage unit store said external input signal input from said input unit as said input data with said period set in said input period storage unit. When receiving an SNMP message instructing said SNMP control unit to set said input period storage unit from said communication network, said SNMP control unit may set said period specified by said SNMP message in said input period storage unit.

The MIB storage unit may have a transmitting condition storage unit operable to store a condition for transmitting said input data to said communication network in such a manner that said condition corresponds to an MIB object, and said SNMP control unit may transmit said input data to said communication network by using a trap message based on SNMP in a case where said input data satisfies said condition set in said transmitting condition storage unit. The transmitting condition storage unit may store a threshold value of said input data as said condition, and said SNMP control unit may transmit said input data to said communication network in a case where a value of said input data exceeds said threshold value.

The semiconductor circuit device may further comprise: an encryption key storage unit operable to store a predetermined encryption key; an IP address storage unit operable to store an IP address of a predetermined server; and an encryption key acquisition unit operable to transmit an encryption key requesting message for requesting transmission of an encryption key to said server by using said IP address stored in said IP address storage unit to obtain a new encryption key, after start-up of said semiconductor circuit device, wherein said SNMP control unit transmits said input data to said communication network by using a message encrypted by said new encryption key. The device to be managed may be a sensor for detecting an outside environment, said input unit may input a value indicating said outside environment as said external input signal, said MIB storage unit may store said external input signal input from said input unit as said input data, and said SNMP control unit may transmit said input data to said communication network by using a message based on SNMP. The sensor may be one of a temperature sensor, a humidity sensor, a smoke sensor and a water sensor, said input unit may input a value indicating a temperature, a value indicating humidity, a value indicating presence and absence of smoke or a value indicating a water volume as said external input signal, the MIB storage unit may store said external input signal input from said input unit as said input data, and said SNMP control unit may transmit said input data to said communication network by using a message based on SNMP.

According to the fourth aspect of the present invention, a management system for detecting an outside environment, comprises: a sensor operable to detect said outside environment; and a semiconductor circuit device connected to said sensor and a communication network, wherein said semiconductor circuit device includes: an input unit operable to input a value indicating said outside environment from said sensor as an external input signal; an MIB storage unit operable to store input data indicating said external input signal input from said input unit in such a manner that said input data corresponds to an MIB (Management Information Base) object in SNMP (Simple Network Management Protocol); and an SNMP control unit operable to transmit said input data corresponding to said MIB object to said communication network by using a message based on SNMP.

According to the fifth aspect of the present invention, a management method for managing an outside device to be managed, comprises: an input step of inputting an external input signal to a semiconductor circuit device connected to a communication network from said device to be managed; an MIB storage step of storing input data indicating said external input signal that was input to said semiconductor circuit device in said input step in such a manner that said input data corresponds to an MIB (Management Information Base) object in SNMP (Simple Network Management Protocol); and an SNMP transmission step of transmitting said input data corresponding to said MIB object to said communication network by using a message based on SNMP.

According to the sixth aspect of the present invention, a semiconductor circuit device connected to a communication network, comprises: a receiving circuit operable to receive an IP packet containing an IP header and a transport header that is a header in a transport layer, from said communication network; an extraction circuit operable to extract said IP header and said transport header from said IP packet; an IP protocol processing circuit operable to perform IP protocol processing based on said IP header extracted by said extraction circuit; and a transport protocol processing circuit operable to perform transport protocol processing based on said transport header extracted by said extraction unit in such a manner that at least of a part of said transport protocol processing is performed in parallel with at least a part of said IP protocol processing.

The extraction circuit may extract said IP header based on a value in an IHL (Internet Header Length) field contained in said IP packet, and, in a case where said IP packet contains a TCP header that is said transport header, may extract said TCP header from said IP packet based on a value in a portion of said TCP header at which a data-offset field is to be positioned and said value in said IHL field. The extraction circuit may extract said IP header based on a value in an IHL (Internet Header Length) field contained in said IP packet and, in a case where said IP packet contains a UDP header that is said transport header, may extract said UDP header from said IP packet based on a value in a portion of said UDP header at which a UDP header length is to be positioned and said value in said IHL field.

The semiconductor circuit device may further comprise a failure processing circuit operable to perform failure processing in a case where said IP protocol processing circuit detected a failure in said IP protocol processing or in a case where said transport protocol processing circuit detected a failure in said transport protocol processing. The IP protocol processing circuit may detect a failure in said IP protocol processing in a case where at least one of following conditions is satisfied: a version number of said IP header is different from a predetermined number; a checksum value of said IP header is different from a value stored in a header-checksum field of said IP header; and a value indicating a service type of said IP header is different from a predetermined value. The transport protocol processing circuit may detect a failure in a case where data that was already received was received again or a case where a trouble occurs in window control of an IP packet.

The semiconductor circuit device may further comprise a session information storage unit operable to store session information indicating a session established between said semiconductor circuit device and a communication device connected to said communication network, wherein said failure processing circuit detects a failure in communication using said session corresponding to said session information stored in said session information storage unit. The failure processing circuit may detect said failure in said communication using said session in a case where said IP packet received from said communication network does not request establishment of a session and a sender IP address and said session information storage unit does not store session information indicating a session specified by a destination IP address that are contained in said IP header of said IP packet and a sender port number and a destination port number contained in said transport header.

According to the seventh aspect of the present invention, a packet processing method for processing an IP packet received from a communication network, comprises: a receiving step of receiving an IP packet containing an IP header and a transport header that is a header in a transport layer from said communication network; an extraction step of extracting said IP header and said transport header from said IP packet; an IP protocol processing step of performing IP protocol processing based on said IP header extracted in said extraction step; and a transport protocol processing step of performing transport protocol processing based on said transport header extracted in said extraction step in such a manner that at least a part of said transport protocol processing is performed in parallel with at least a part of said IP protocol processing.

According to the eighth aspect of the present invention, a semiconductor circuit device connected to a communication network, comprises: a plurality of received queues; a received queue selection circuit operable to one of said plurality of received queues for each of a plurality of received packets received from said communication network based on a header of that received packet and to store that received packet in said selected one of said plurality of received queues; and a processing order determination circuit operable to determine a processing order in which transport protocol processing is to be performed for each of said plurality of received packets stored in said plurality of received queues based on priorities of said plurality of received queues. The semiconductor circuit device may further comprise a priority determination circuit operable to determine, based on a header of said received packet, a priority of said received queue storing said received packet.

The received queue selection circuit may identify a session corresponding to said received packet based on a header of said received packet and selects said one received queue that is to store said received packet based on said identified session, and said priority determination circuit may determine said priority based on said session corresponding to said received packet. The received queue selection circuit identify a session corresponding to said received packet based on a header of said received packet and selects said one received queue that is to store said received packet based on said identified session, and said priority determination circuit may determine said priority based on said session corresponding to said received packet and a code bit contained in a TCP header of said received packet.

The priority determination circuit may determine said priority based on a destination port number contained in a TCP header of said received packet. The priority determination circuit may determine said priority based on a sender address contained in an IP header corresponding to said received packet. The priority determination circuit may determine said priority based on a bandwidth that was set in advance for each of said plurality of received queues.

The semiconductor circuit device may further comprise a transport receiving processing circuit operable to perform transport protocol processing for said received packet, wherein said plurality of received queues include at least one high-priority receive queue having high priority and a plurality of low-priority receive queues having lower priorities than said priority of said high-priority received queue, in a case where said high-priority received queue stores said received packet, said transport receive processing circuit processes said received packet, said processing order determination circuit selects one of said plurality of low-priority received queues one by one in said order that was set in advance every time said transport receive processing circuit processes said received packet stored in said low-priority received queue, and in a case where said high-priority received queue stores no received packet, said transport receive processing circuit processes said received packet stored in said low-priority received queue selected by said processing order determination circuit.

The received queue selection circuit may select said received queue that is to store said received packet based on at least one of a session corresponding to said received packet, a code bit contained in a TCP header of said received packet, a destination port number contained in said TCP header of said received packet and a sender address contained in an IP header of said received packet, and said processing order determination circuit may determine said processing order in which said transport protocol processing is to be performed based on which of said plurality of received queues each of said plurality of received packets is stored in.

The semiconductor circuit device may further comprise a transmitted queue operable to store a transmitted packet that is to be transmitted to said communication network, wherein said processing order determination circuit determines said processing order in which said transport protocol processing is to be performed for each of said plurality of received packets stored in said plurality of received queues and said transmitted packet stored in said transmitted queue, based on priorities of said plurality of received queues and a priority of said transmitted queue.

According to the ninth aspect of the present invention, a packet processing method for processing a plurality of received packets that were received from a communication network, comprises: a received queue selection step of selecting one of said plurality of received queues for each of said plurality of received packets based on a header of that received packet and storing that received packet in said selected one received queue; and a processing order determination step of determining a processing order in which transport protocol processing is to be performed for each of said plurality of received packets stored in said plurality of received queues based on priorities of said plurality of received queues.

According to the tenth aspect of the present invention, a management system for detecting an outside environment, comprises: a sensor operable to detect said outside environment; a semiconductor circuit device connected to said sensor and a communication network; and a management device connected to said communication network, wherein said semiconductor device includes an MIB storage unit for inputting input data indicating said outside environment from said sensor and store said input data in such a manner that said input data corresponds to an MIB (Management Information Base) object in SNMP (Simple Network Management Protocol), and said management device includes: a contact information database operable to store contact information of a user of said semiconductor circuit device in such a manner that said contact information corresponds to said semiconductor circuit device; an SNMP management unit operable to obtain said input data from said semiconductor circuit device; and a notification unit operable to obtain said contact information of said user of said semiconductor circuit device in a case where said input data satisfies a condition that was set in advance and notify said user that said input data satisfies said condition. The SNMP management unit may obtain said input data from said semiconductor circuit device with an obtaining period that was set in advance. The SNMP management unit may request a response to said semiconductor circuit device with a response-requesting period that was set in advance, and, in a case where said semiconductor circuit device does not respond to said request, said notification unit may obtain said contact information of said user of said semiconductor circuit device from said contact information database and notifies said user that said semiconductor circuit device does not respond.

The semiconductor circuit device may further include an SNMP control unit operable to, in a case where said input data satisfies said condition, transmit a trap message based on SNMP, indicating that said input data satisfies said condition, to said management device via said communication network, the SNMP management unit may obtain said trap message as said input data, and said notification unit may notify said user that said input data satisfies said condition in a case where said SNMP management device obtained said trap message.

A plurality of management devices may be provided; said SNMP control unit may confirm that communication with one of said plurality of management devices is available with a confirming period that was set in advance; in a case where said communication with said one management device is available and said input data satisfies said condition that was set in advance, said SNMP control unit may transmit said trap message indicating that said input data satisfies said condition to said one management device; in a case where said communication with said one management device is not available, said SNMP control unit may transmit a message indicating that said communication with said one management device is not available to another one of said plurality of management devices; and in a case where said another management device received said message indicating that said communication with said one management device is not available, said notification unit of said another management device may obtain said contact information of said user of said semiconductor device from said contact information database and notifies said user that said communication with said one management device is not available.

The MIB storage unit may include a number-of-transmission storage unit operable to store a number of transmissions of said trap message to said management device in a case where said input data satisfies said condition that was set in advance, in such a manner that said number of transmissions corresponds to an MIB object; the SNMP management unit may set said number of transmissions of said semiconductor circuit device by using a message based on SNMP; and the SNMP control unit may transmit said trap message to said management device a number of times in a case where said input data satisfies said condition that was set, said number of transmitted times being specified by said number of transmissions set by said management device.

The contact information database may store contact information of a mobile communication terminal, and said notification unit may obtain said contact information of said mobile communication terminal as said contact information of said user of said semiconductor circuit device and notifies said user that said input data satisfies said condition that was set in advance. The said management device may further include a browsed data storage unit operable to store said input data in such a manner that said input data is able to be browsed from said mobile communication terminal, in a case where said notification unit notified said user of said semiconductor circuit device.

The semiconductor circuit device may further include: an input unit operable to input an analog value indicating said outside environment from said sensor; and an AD conversion unit operable to convert said analog value into a digital value, wherein said MIB storage unit stores said digital value as said input data. The sensor may be any one of a temperature sensor, a humidity sensor, a smoke sensor or a water sensor, and the MIB storage unit may input a value indicating a temperature, a value indicating humidity, a value indicating presence or absence or a value indicating a water volume as said input data in accordance with said sensor.

The summary of the invention does not necessarily describe all necessary features of the present invention. The present invention may also be a sub-combination of the features described above.

### BRIEF DESCRIPTION OF DRAWINGS

FIG. 1 is a management system according to an embodiment of the present invention.

FIG. 2 shows an exemplary structure of a sensor control device according to the embodiment of the present invention.

FIG. 3 shows an exemplary detailed structure of an environmental acquisition unit and an MIB storage unit.

FIG. 4 shows an exemplary structure of MIB stored in the MIB storage unit.

FIG. 5 shows an exemplary structure of an encryption-related processing unit.

FIG. 6 is a flowchart of an exemplary operation of the sensor control device according to the embodiment of the present invention.

FIG. 7 is a flowchart of an exemplary operation of a management device according to the embodiment of the present invention.

FIG. 8 shows an exemplary hardware configuration of a personal computer.

FIG. 9 shows an exemplary structure of an SNMP control unit.

FIG. 10 is a flowchart of an exemplary operation of the SNMP control unit.

FIG. 11 shows an exemplary structure of a communication processing circuit.

FIG. 12 is a flowchart of an exemplary operation of the communication processing circuit.

FIG. 13 shows an exemplary detailed structure of a transport protocol processing circuit.

FIG. 14 shows an exemplary detailed structure of a priority determination circuit.

FIG. 15 is a flowchart of an exemplary operation of the transport protocol processing circuit.

FIG. 16 is a flowchart of an exemplary operation of a processing order determination circuit.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

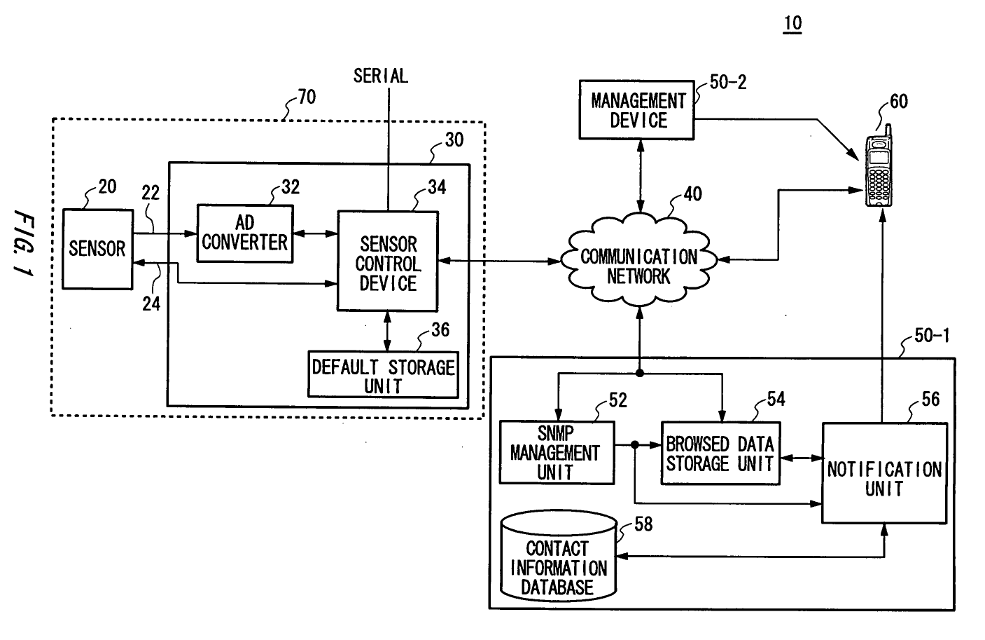

FIG. 1 shows an exemplary structure of a management system 10 according to an embodiment of the present invention. In the present embodiment, the management system 10 manages a sensor 20, that is an exemplary device to be managed (managed object) that does not have an IP network connection function, in accordance with SNMP (Simple Network Management Protocol).

The management system 10 includes a plurality of management devices 50-1 and 50-2 and a system to be managed 70 that are mutually connected via a communication network 40.

The system to be managed 70 is an exemplary IP application that performs processing based on IP communication. In the present embodiment, the system to be managed 70 performs processing in accordance with SNMP that is an exemplary protocol based on IP. The system to be managed 70 may further perform processing in accordance with another protocol based on IP, such as HTTP (Hyper Text Transfer Protocol) or a multimedia call control protocol. In the present embodiment, the system to be managed 70 includes a sensor 20 and an agent device 30.

The sensor 20 is provided in the outside of the agent device 30. The sensor 20 detects the environment in the outside of the system to be managed 70 and supplies a value indicating the outside environment to the agent device 30 as an external input signal. The sensor 20 is a temperature sensor, a humidity sensor, a smoke sensor, or a water sensor, for example, and may output a value indicating a temperature, a value indicating humidity, a value indicating the presence or absence of the smoke, or a value indicating a volume of water as the external input signal in accordance with the sensor 20.

In the present embodiment, the sensor 20 supplies the external input signal that is an analog signal to the agent device 30. Alternatively, the sensor 20 may output the external input signal in form of digital signal. For example, the sensor 20 serving as the temperature sensor may output an analog or digital signal indicating the temperature as the external input signal to the agent device 30.

The agent device 30 has a function of proxy agent in SNMP and is removably connected to the sensor 20. The agent device 30 includes an AD converter 32, a sensor control device 34 and a default storage unit 36.

The AD converter 32 performs AD conversion of the external input signal received from the sensor 20 via an analog transmission line 22. For example, the AD converter 32 is connected to the sensor control device 34 via SPI (Serial Peripheral Interface) or the like, and performs AD conversion in accordance with setting parameters received from the sensor control device 34. The sensor control device 34 then receives the external input signal that was converted to a digital signal by the AD converter as input data and transmits environmental data indicated by the external input signal to the communication network 40 by using a message based on SNMP.

The sensor control device 34 has a serial interface that can be connected to the outside of the system to be managed 70. The sensor control device 34 may be connected to the management device 50-1 or the sensor 20 via the serial interface, for example.

The sensor control device 34 controls the sensor 20 by supplying a command to the sensor 20 via a digital transmission line 24. Moreover, the sensor control device 34 may receive a status signal indicating a status of the sensor 20 or the external input signal that is a digital signal, for example, via the digital transmission line 24. The command output unit 306 may supply a control signal to the sensor 20.

The sensor control device 34 may receive an operating power from the sensor 20 or the digital transmission line 24. The digital transmission line 24 may be a serial interface such as RS-232C or SPI, or a DIO interface having a plurality of bits.

The default storage unit 36 stores information to be set in the sensor control device 34 in initialization of the sensor control device 34, such as an IP address of the management device 50-1 or the like. The default storage unit 36 may be an EEPROM or a flash memory, for example. The sensor control device 34 accesses the default storage unit 36 at the startup and obtains the information to be set in the initialization of the sensor control device 34.

In an alternative embodiment, the agent device 30 may further include a CPU connected to the sensor control device 34. That CPU may perform a part of processing based on SNMP, for example.

Each of a plurality of management devices 50-1 and 50-2 has a network management station (manager) in SNMP and manages the system to be managed 70 by transmitting/receiving one or more messages based on SNMP to/from the system to be managed 70. The management device 50-1 includes an SNMP management unit 52, a browsed data storage unit 54, a notification unit 56 and a contact information database 58.

The SNMP management unit 52 obtains environmental data from the sensor control device 34, using a message based on SNMP. In other words, the SNMP management unit 52 obtains the environmental data by regularly polling the system to be managed 70 or by a trap message received from the system to be managed 70.

The contact information database 58 stores contact information of the user of the sensor control device 34 in such a manner that the contact information corresponds to the sensor control device 34. In the present embodiment, the contact information database 58 stores the contact information of the cellular phone 60 that is an exemplary mobile communication terminal as the contact information. Alternatively, the contact information database 58 may store the e-mail address or the fax number of the user of the sensor control device 34 as the contact information, for example.

In a case where the environmental data satisfies a predetermined condition, the notification unit 56 notifies the user of the sensor control device 34 that the environmental data satisfies the predetermined condition. The notification unit 56 may give that notification, for example, in a case where a value of the environmental data obtained in response to polling exceeded a predetermined threshold value or a case where the environmental data was obtained by the trap message. In a case of giving the notification, the notification unit 56 gives the notification after obtaining the contact information of the cellular phone 60 from the contact information database 58. In this case, the notification unit 56 may give the notification a predetermined number of times. Moreover, the notification unit 56 may give the notification to the cellular phone 60 by a voice message or a character message.

The browsed data storage unit 54 stores the environmental data in such a manner that the environmental data can be browsed from the cellular phone 60, in a case where the notification unit 56 gave the notification to the user of the sensor control device 34. For example, the browsed data storage unit 54 may store the environmental data in a website that is accessible by a web-browser function of the cellular phone 60.

Alternatively, the browsed data storage unit 54 may store the environmental data in a website that is accessible from the cellular phone 60, provided on a server in the outside of the management device 50-1, by transmitting data containing the environmental data to that server.

The management device 50-2 has the same or similar function as that of the management device 50-1 and therefore the description thereof is omitted. The system to be managed 70 communicates with the management device 50-2, for example, in a case where communication with the management device 50-1 is not available.

In the present embodiment, the management device 50-1 controls and monitors the sensor 20 via the agent device 30 having a communication function based on SNMP. Therefore, according to the present embodiment, it is possible to provide a management system in which a sensor having no IP network connection function is managed in accordance with SNMP so as to detect the outside environment. Moreover, it is also possible to provide a system that remotely manages and monitors the sensor in accordance with a standard protocol of the Internet and performs measurement. Furthermore, according to the present embodiment, a system and a solution for performing the management and monitor of the sensor 20 that are integrated can be provided. Please note that SNMP may be a protocol defined based on SNMP or a protocol that will be defined in the future based on SNMP.

In the above description, the communication network 40 may be a wide area network such as the Internet or another network of public lines, a local network or the like.

The sensor control device 34 is an exemplary control device that controls various types of device under control, such as a stand-alone device that is not networked and a non-computer device. The sensor control device 34 may be connected to such a device under control that is a managed object so as to control the device under control while managing and/or monitoring that device, in place of the sensor 20.

The sensor control device 34 may communicate with the management device 50-1 in accordance with HTTP, a multimedia call control protocol or a TELNET protocol, that is an exemplary protocol based on IP, in place of SNMP. In this case, the management device 50-1 can control the device to be managed based on the above protocol. Therefore, according to the present embodiment, a management system and an IP network solution that manage a device to be managed having no IP network connection function can be provided at a low cost.

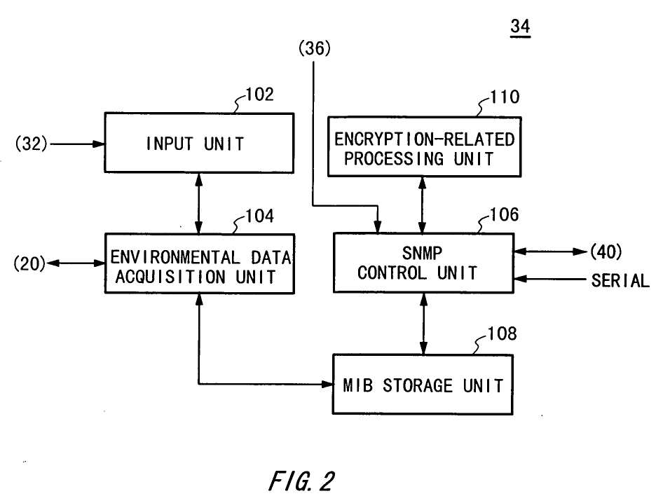

FIG. 2 shows an exemplary structure of the sensor control device 34 according to the present embodiment. The sensor control device 34 is a semiconductor circuit device formed on a single semiconductor chip, and includes an input unit 102, an environmental data acquisition unit 104, an MIB storage unit 108, an SNMP control unit 106 and an encryption-related processing unit 110.

The input unit 102 inputs an external input signal from the AD converter 32. The environmental data acquisition unit 104 supplies input data indicating the external input signal input from the input unit 102, to the MIB storage unit 108 as environmental data. The environmental data acquisition unit 104 gives a command for controlling the sensor 20 to the sensor 20.

The MIB storage unit 108 stores the environmental data in such a manner that the environmental data corresponds to an MIB (Management Information Base) object in SNMP. MIB may be placed with a data structure defined based on MIB or a data structure that will be defined based on MIB in the future.

The SNMP control unit 106 receives the environmental data from the MIB storage unit 108 and transmits the environmental data to the communication network 40 by using a message based on SNMP. In this case, the SNMP control unit 106 may transmit the environmental data in response to a request (or polling) from the management device 50-1 (see FIG. 1), or may transmit the environmental data by a trap message in a case where the environmental data satisfies a predetermined condition, for example. Moreover, the SNMP control unit 106 may encrypt the environmental data with an encryption key obtained from the encryption-related processing unit 110 so as to transmit the encrypted environmental data.

In addition, the SNMP control unit 106 manages an MIB object that is used for receiving the command for controlling the sensor 20 from the communication network 40. In this case, the MIB storage unit 108 stores that command so as to correspond to the MIB object. The environmental data acquisition unit 104 receives that command from the MIB storage unit 108 and supplies it to the sensor 20.

The SNMP control unit 106 may be connected to the management device 50-1 via a serial interface, for example. In this case, the SNMP control unit 106 may receive a command via the serial interface.

The SNMP control unit 106 may further perform processing based on a protocol implemented on IP, such as HTTP, a multimedia call protocol or a TELNET protocol, for example.

The MIB storage unit 108 is an example of an obtained information storage unit that stores information obtained based on the protocol implemented on IP. The MIB storage unit 108 may obtain information to be set in the sensor control device 34, for example, from the management device 50-1 based on HTTP, a multimedia call control protocol, or a TELNET protocol and may store that information therein.

In the present embodiment, the sensor control device 34, that is a semiconductor circuit device formed on a semiconductor chip, has a function of outputting a command for controlling the sensor 20 and a function of generating an SNMP message indicating the external input signal received from the sensor 20. According to the present embodiment, it is possible to provide a small-sized and low power consumption agent device 30 that operates at a high speed, at a low cost. Please note that the sensor control device 34 may be ASIC having the command outputting function and the SNMP message generation function, for example. It is preferably that the sensor control device 34 be a monolithic IC.

In an alternative embodiment, the sensor control device 34 may be divided into a plurality of parts respectively formed on a plurality of semiconductor chips. In this case, those semiconductor chips are placed in a single package to form an MCP (Multi Chip Module). In this case, it is also possible to provide the agent device 30 at a low cost.

In the present embodiment, the sensor control device 34 receives the external input signal that was converted into a digital signal by the AD converter 32 provided in the outside of the sensor control device 34. Alternatively, the sensor control device 34 may include the AD converter 32. In this case, the input unit 102 receives the external input signal in form of analog signal from the sensor 20, and then the AD converter 32 converts that analog signal into a digital signal, thereby generating environmental data, and thereafter supplies the environmental data to the MIB storage unit 108 via the environmental data acquisition unit 104. In this case, it is possible to provide the agent device 30 at a further reduced cost.

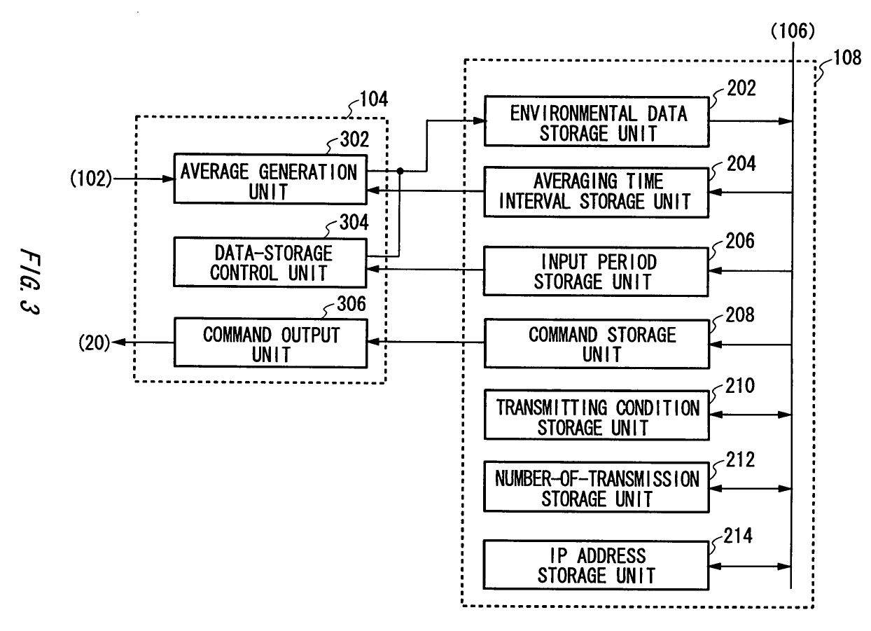

FIG. 3 shows an exemplary detailed structure of the environmental data acquisition unit 104 and the MIB storage unit 108. The environmental data acquisition unit 104 includes an average generation unit 302, a data-storage control unit 304, and a command output unit 306.

The average generation unit 302 receives an external input signal from the input unit 102 and generates environmental data by calculating an average of a value of the external input signal. In this case, the average generation unit 302 calculates the average at a time interval that was set in an averaging time interval storage unit 204.

The average generation unit 302 may generate the environmental data by hardware processing. In this case, the average generation unit 302 may receive the external input signal at a high sampling rate, for example, every one second, so as to calculate the average. Moreover, the averaging time interval storage unit 204 may specify the number of sampling times as the time interval for average generation.

The data-storage control unit 304 stores the environmental data in an environmental storage unit 202 with a period that was set in an input period storage unit 206. The command output unit 306 receives a command from a command storage unit 208 and supplies it to the sensor 20.

The MIB storage unit 108 includes the environmental data storage unit 202, the averaging time interval storage unit 204, the input period storage unit 206, the command storage unit 208, a transmitting condition storage unit 210, a number-of-transmission storage unit 212 and an IP address storage unit 214. The environmental data storage unit 202 stores environmental data; the averaging time interval storage unit 204 stores the time interval at which the average of the value of the external input signal is calculated; the input period storage unit 206 stores a period of inputting the value of the external input signal; the command storage unit 208 stores a command to be sent to the sensor 20; the transmitting condition storage unit 210 stores a condition that allows transmission of the environmental data by the SNMP control unit 106; the number-of-transmission storage unit 212 stores the repeat number of the trap message; and the IP address storage unit 214 stores IP addresses of a plurality of management devices 50-1 and 50-2 (see FIG. 1). They store the above-described units of information so as to be associated with MIB objects, respectively.

The MIB storage unit 108 receives the information to be stored therein from the SNMP control unit 106. The SNMP control unit 106 receives defaults to be stored in the MIB storage unit 108 from the default storage unit 36 (see FIG. 1) at the startup, and supplies the defaults to the MIB storage unit 108.

In a case where the SNMP control unit 106 received an SNMP message indicating update of the MIB storage unit 108 from the communication network 40 after the startup of the default storage unit 36, the SNMP control unit 106 updates the information stored in the MIB storage unit 108 in accordance with the received SNMP message. For example, when receiving an SNMP message instructing the SNMP control unit 106 to perform setting of the averaging time interval storage unit 204, the SNMP control unit 106 sets the time interval specified by the received SNMP message in the averaging time interval storage unit 204. When receiving an SNMP message instructing the SNMP control unit 106 to perform setting of the input period storage unit 206, the SNMP control unit 106 set the period specified by the received SNMP message in the input period storage unit 206. When receiving an SNMP message containing a command to the sensor 20 from the communication network 40, the SNMP control unit 106 sets the command specified by the received SNMP message in the command storage unit 208.

The sensor control device 34 may change the IP address/addresses of the management device 50-1 and/or the management device 50-2 based on a request from an external server or the like. In this case, the management device that is to manage the sensor control device 34 can be changed via the communication network 40.

In the present embodiment, the MIB storage unit 108 stores the command to be supplied to the sensor 20 and the environmental data based on the external input signal received from the sensor 20 in such a manner that the command and the environmental data correspond to the MIB objects, respectively. Thus, the management device 50-1 manages the sensor 20 via the MIB objects having predetermined data structures. Therefore, according to the present embodiment, irrespective of the type of the sensor 20, the sensor 20 can be managed appropriately.

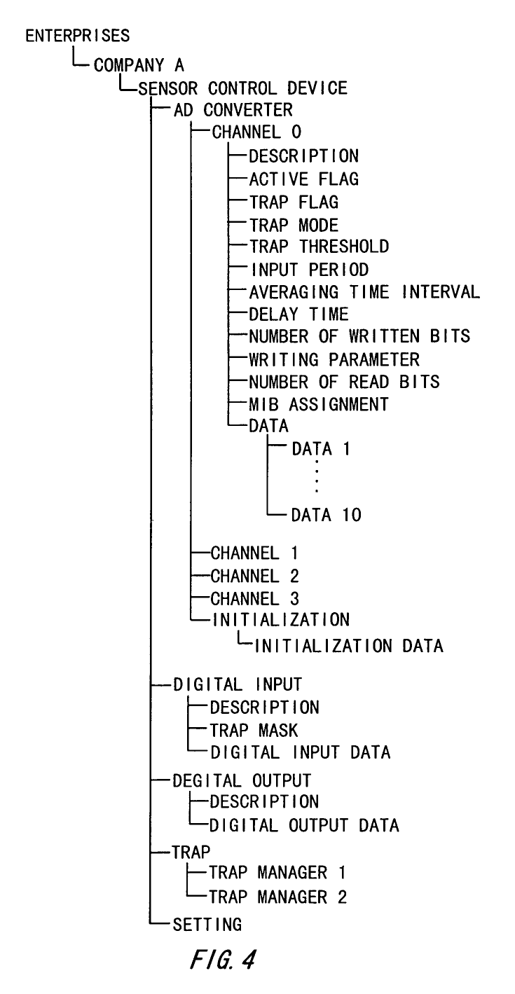

FIG. 4 shows an exemplary structure of MIB stored in the MIB storage unit 108 (see FIG. 3). In the present embodiment, the MIB storage unit 108 stores a sensor-control-device sub-tree contained in a sub-tree of Company A, that is a manufacturer of the sensor control device 34 (see FIG. 1), for example, defined under an enterprises sub-tree (.1.3.6.1.4.1). The management device 50-1 (see FIG. 1) sets a value of an MIB object under the Company A sub-tree by using an SNMP message.

In the present embodiment, the MIB storage unit 108 further stores standard MIB sub-trees (not shown) used in management of configuration, failure management, performance management, security management and accounting management, for example. The management device 50-1 sets values of MIB objects under those standard MIB sub-trees by using SNMP messages.

The sensor-control-device sub-tree contains an AD converter sub-tree used for managing the AD converter 32 (see FIG. 1), a digital input sub-tree used for receiving a digital signal from the sensor 20 (see FIG. 1), a digital output sub-tree used for sending a digital signal to the sensor 20, a trap sub-tree used for sending a trap message to the management devices 50-1 and 50-2 (see FIG. 1) and a setting object.

The AD converter sub-tree has a channel 0 sub-tree, a channel 1 sub-tree, a channel 2 sub-tree and a channel 3 sub-tree that correspond to analog input terminals of the AD converter 32, respectively, and an initialization sub-tree. In the present embodiment, the AD converter 32 has four analog input terminals respectively corresponding to channels 0-3. The sensor 20 may supply the external input signal to one or more analog input terminals of the AD converter 32.

The channel 0 sub-tree contains MIB objects respectively indicating description, an active flag, a trap flag, a trap mode, a trap threshold, the input period, the averaging time interval, delay time, the number of written bits, a writing parameter, the number of read bits and MIB assignment, and also contains a data sub-tree.

The description object indicates information for identifying the name or function of the channel 0 of the AD converter 32. The active-flag object indicates whether or not the channel 0 is active. The trap-flag object sets whether or not the SNMP control unit 106 (see FIG. 2) is allowed to transmit a trap message.

The trap-mode object indicates the number of the repeat times of the transmission of the trap message. The trap-threshold object indicates a threshold value of environmental data. In a case where the value of the environmental data exceeded that threshold value, the SNMP control unit 106 transmits the environmental data to the communication network 40 by using the trap message. The SNMP control unit 106 may transmit the trap message in a case where the environmental data has changed to a value larger than that threshold value or a value smaller than that threshold value.

The trap-threshold object may indicate an upper-limit threshold value and a lower-limit threshold value. In this case, the SNMP control unit 106 may transmit the trap message in a case where the environmental data changed to a value larger than the upper-limit threshold value or a value smaller than the lower-limit threshold value.

The input-period object indicates a period with which the environmental data is newly stored in the environmental data storage unit 202. The averaging-time-interval object indicates a time interval at which the output of the AD converter 32 is averaged. The delay-time object indicates delay time until the AD converter 32 outputs data in response to the output of the command to the AD converter 32. The number-of-written-bits object indicates the bit length of a command or setting parameter that is given to the AD converter 32. The writing-parameter object indicates a command or setting parameter that is given to the AD converter 32. The number-of-read-bits object indicates the bit length of digital data received from the AD converter 32.

The MIB assignment object indicates assignment of the channel 0 that is a physical channel, to a logical channel. The management device 50-1 (see FIG. 1) accesses the sensor control device 34 while specifying the logical channel, and the sensor control device 34 accesses the physical channel of the AD converter 32 corresponding to the specified logical channel.

The data sub-tree contains ten MIB objects corresponding to data 1 to data 10. The data 1 object to the data 10 object indicate the environmental data received from the AD converter 32, respectively. The channel 1 sub-tree, the channel 2 sub-tree and the channel 3 sub-tree have the same or similar structure as that of the channel 0 sub-tree and therefore the description thereof is omitted.

The initialization sub-tree contains initialization-data object indicating a command or setting parameter for initializing the AD converter 32. For example, the initialization-data object indicates a gain or offset to be set in the AD converter 32.

The digital input sub-tree contains MIB objects respectively indicating description, a trap mask and digital input data. The description object indicates the name of a digital signal that the sensor control device 34 receives from the sensor 20 via the digital transmission line 24 (see FIG. 1) or information for identifying the type of that digital signal. The trap-mask object is used for selecting the bit used in detection of the condition of transmitting a trap signal. The digital-input-data object indicates the value of the digital signal received from the sensor 20.

The digital output sub-tree contains MIB objects respectively indicating description and digital output data. The description object indicates the name of a command or data that is a digital signal that the sensor control device 34 supplies to the sensor 20 via the digital transmission line 24, or information for identifying the format of communication via the digital transmission line 24. The digital-output-data object is used for writing the digital signal supplied via the digital transmission line 24 to the sensor 20.

The trap sub-tree contains MIB objects respectively indicating trap managers 1 and 2. The trap-manager 1 object indicates the IP address of the management device 50-1. The ×trap-manager 2 object indicates the IP address of the management device 50-2.

The setting object is an MIB object indicating the update value of the memory contents of the default storage unit 36 (see FIG. 1). The management device 50-1 updates the memory contents of the default storage unit 36 by setting the value in the setting object and restarting the sensor control device 34.

In the above description, an MIB object other then the MIB object indicating the input data received from the sensor 20 or the AD converter 32 may be rewritable by the management device 50-1 and the like. Thus, the user of the sensor control device 34 can perform setting or the like of the sensor 20, the AD converter 32, the sensor control device 34 and the default storage unit 36 via the communication network 40.

In the present embodiment, the environmental data storage unit 202 (see FIG. 3) stores the values of the data 0 object to the data 10 object. The averaging time interval storage unit 204 (see FIG. 3) stores the value of the averaging-time-interval object. The input period storage unit 206 (see FIG. 3) stores the value of the input-period object. The command storage unit 208 (see FIG. 3) stores the value of the digital-output-data object. The transmitting condition storage unit 210 (see FIG. 3) stores the values of the trap-flag object and the trap-threshold object. The number-of-transmission storage unit 212 (see FIG. 3) stores the value of the trap-mode object. The IP address storage unit 214 (see FIG. 3) stores the values of the trap-manager 1 object and trap-manager 2 object.

In this manner, the MIB storage unit 108 stores the environmental data to make the environmental data correspond to the objects of data 1-10 (input-data MIB objects) that do not depend on the type of the sensor 20 and also stores the command to be supplied to the sensor 20 so as to make the command correspond to the digital-output-data object (command MIB object) that does not depend on the type of the sensor 20. The SNMP control unit 106 transmits the environmental data that were made to correspond to the objects of data 1-10, to the communication network 40. Moreover, the command output unit 306 supplies the command that was made to correspond to the digital-output-data object to the sensor 20. According to the present embodiment, the agent device 30 can manage various types of sensor 20 in accordance with SNMP by using MIB having a general-purpose structure that does not depend on the type of the sensor 20. In addition, it is possible to manage different types of device to be managed by the same hardware processing, for example.

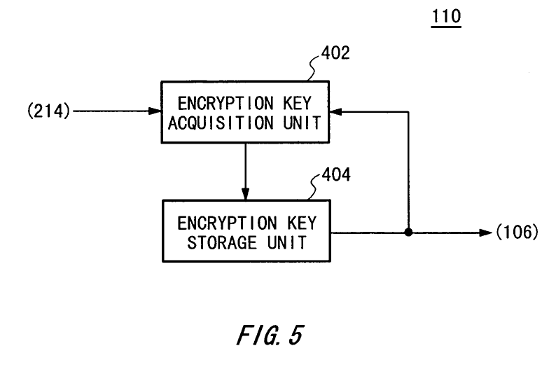

FIG. 5 shows an exemplary structure of the encryption-related processing unit 110. The encryption-related processing unit 110 includes an encryption key acquisition unit 402 and an encryption key storage unit 404. The encryption key acquisition unit 402 obtains an encryption key from the default storage unit 36 (see FIG. 1) via the SNMP control unit 106 at the startup of the sensor control device 34 and stores the obtained encryption key in the encryption key storage unit 404.

Moreover, the encryption key acquisition unit 402 transmits an encryption-key-request message for requesting transmission of an encryption key to the management device 50-1 after the startup of the sensor control device 34 and obtains a new encryption key from the management device 50-1. In this case, the encryption key acquisition unit 402 obtains the IP address of the management device 50-1 from the IP address storage unit 214 (see FIG. 3).

The encryption key storage unit 404 updates the stored encryption key to the new encryption key, and the SNMP control unit 106 transmits the environmental data to the communication network 40 by using an SNMP message encrypted by the new encryption key. According to the present embodiment, since the encryption key is newly obtained every time the sensor control device 34 starts, the management device 50-1 can perform highly confidential communication with the system to be managed 70.

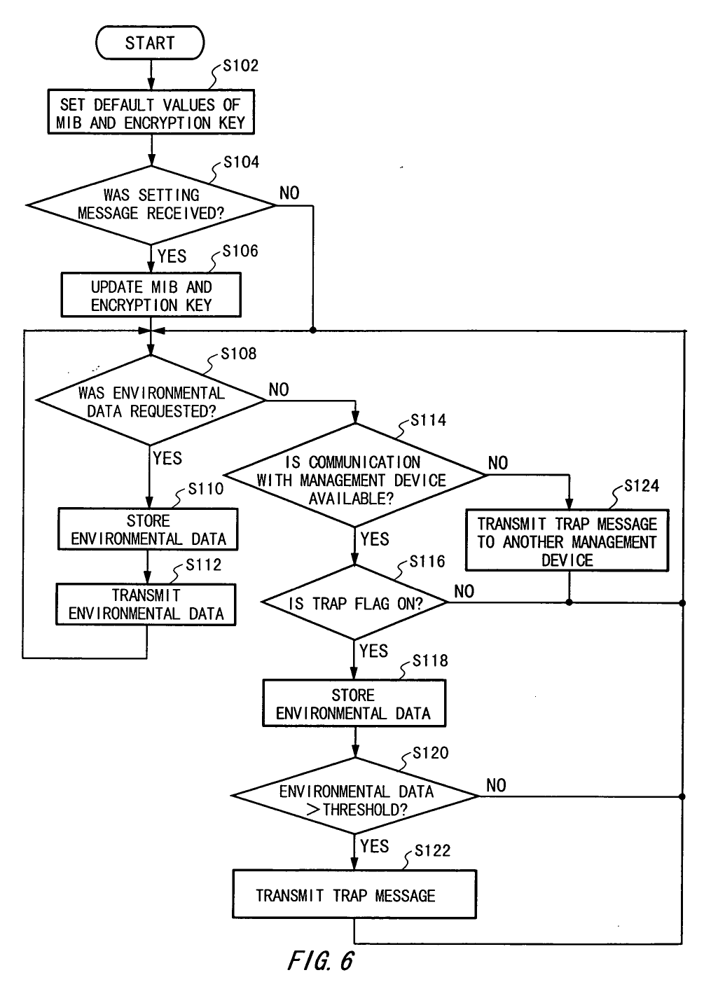

FIG. 6 is a flowchart of an exemplary operation of the sensor control device 34 according to the present embodiment. First, the sensor control device 34 obtains data stored in the default storage unit 36 and sets default values of MIB stored in the MIB storage unit 108 and the encryption key stored in the encryption key storage unit 404 (Step S102). In a case where the sensor control device 34 received an SNMP message for setting MIB or the encryption key from the management device 50-1 (Step S104), the sensor control device 34 updates MIB and/or the encryption key in accordance with the received MIB message (Step S106).

In a case where the sensor control device 34 received a request for environmental data from the management device 50-1 (Step S108), the sensor control device 34 stores the environmental data obtained from the AD converter 32 in the environmental data storage unit 202 so as to make the environmental data correspond to the MIB objects (Step S110). Then, the sensor control device 34 transmits the environmental data to the management device 50-1 by using an SNMP message (Step S112) and waits for a next request for environmental data (Step S108). On the other hand, in a case where the sensor control device 34 did not receive the SNMP message for updating MIB or the encryption key, the sensor control device 34 waits for a request for the environmental data in Step S108.

The request for environmental data in Step S108 is an SNMP message for instructing the sensor control device 34 to send a command for making the sensor 20 output the external input signal, for example. In this case, the command output unit 306 supplies that command to the sensor 20 and the sensor 20 outputs the external input signal in response to the command.

In a case where the sensor control device 34 received no request for environmental data in Step S108, the SNMP control unit 106 confirms whether or not communication with the management device 50-1 is available (Step S114). The SNMP control unit 106 may confirm that it can communicate with the management device 50-1 by transmitting a message such as ping to the management device 50-1 with a confirming period that was set in advance.

Then, in a case where communication with the management device 50-1 is available and the trap-flag object is set to a value that allows transmission of a trap message (Step S116), the sensor control device 34 obtains the environmental data from the AD converter 32 and stores the environmental data in the environmental data storage unit 202 (Step S118).

Then, in a case where the environmental data is larger than the threshold value indicated by the threshold object stored in the transmitting condition storage unit 210 (Step S120), the SNMP control unit 106 transmits a trap message to the management device 50-1 (Step S122) and returns to Step S108 in which the SNMP control unit 106 waits for the request for the environmental data.

In Step S120, the SNMP control unit 106 may transmit the trap message in a case where the environmental data is smaller than the threshold value. In Step S122, the SNMP control unit 106 transmits the trap message one or more times to the management device 50-1, the number of transmission times being specified by the trap-mode object.

In Step S114, in a case where the SNMP control unit 106 cannot communicate with the management device 50-1, the sensor control device 34 transmits a trap message that indicates that communication with the management device 50-1 is not available to the management device 50-2. In this case, the notification unit 56 of the management device 50-2 obtains contact information of the user from the sensor control device 34 from the contact information database 58 and then notifies the user that communication with the management device 50-1 is not available.

According to the present embodiment, the sensor control device 34 transmits the environmental data to the management device 50-1 in response to the request for the environmental data from the management device 50-1 or by an operation in accordance with the value of the MIB object the management device 50-1 set in advance. According to the present embodiment, the management device 50-1 can manage the sensor control device 34 in an appropriate manner so as to obtain the environmental data.

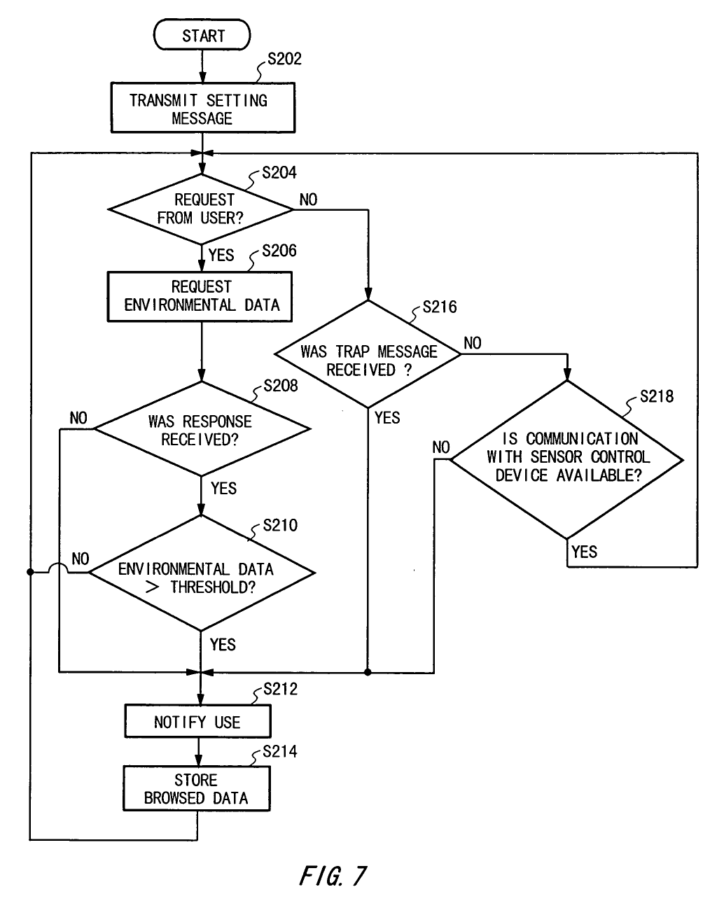

FIG. 7 is a flowchart of an exemplary operation of the management device 50-1 according to the present embodiment. The management device 50-1 first transmits an SNMP message for making the sensor control device 34 set MIB and/or the encryption key stored in the sensor control device 34 (Step S202). In a case where the user of the sensor control device 34 requested the environmental data (Step S204), the SNMP management unit 52 requests the environmental data to the sensor control device 34 (Step S206). Then, in a case where the sensor control device 34 sent a response (Step S208), the SNMP management unit 52 compares the received environmental data with a predetermined threshold value (Step S210). In a case where the environmental data is larger than the threshold value, the notification unit 56 obtains the contact information of the user of the sensor control device 34 from the command storage unit 208 and notifies the cellular phone 60 of the user that the environmental data is larger than the threshold value (Step S212). Then, the browsed data storage unit 54 stores the environmental data in such a manner that the environmental data can be browsed from the cellular phone 60 (Step S214). Alternatively, the notification unit 56 may notify the user in a case where the environmental data is smaller than the threshold value.

In Step S204, in a case where the user did not request the environmental data, the management device 50-1 waits for a trap message that will be transmitted from the sensor control device 34 (Step S216). Then, when the management device 50-1 received the trap message indicating the environmental data, the management device 50-1 gives a notification to the user in Step S212. In a case where the management device 50-1 received no trap message in Step S216, the management device 50-1 confirms whether or not communication with the sensor control device 34 is available (Step S218). In a case where that communication is not available, the management device 50-1 notifies the user that the management device 50-1 cannot communicate with the sensor control device 34 in Step S212. In Step S218, the management device 50-1 may confirm that it can communicate with the sensor control device 34 by transmitting a message such as ping to the sensor control device 34.

Moreover, also in a case where the sensor control device 34 did not respond in Step S208, the management device 50-1 notifies the user that it cannot communicate with the sensor control device 34 in Step S212. In this manner, the SNMP management unit 52 requests a response to the sensor control device 34 with a predetermined responding period, thereby confirming the status of the sensor control device 34. The notification unit 56 may notify the user, in a case where the sensor control device 34 gave no response to a predetermined number of requests for the environmental data (polling).

In a case where the environmental data is smaller than the threshold value in Step S210 and a case where it was confirmed that communication with the sensor control device 34 was available in Step S218, the operation returns to Step S204 where the management device 50-1 confirms again whether or not the user requested the environmental data. Moreover, in Step S204, the SNMP management unit 52 may request the environmental data with a predetermined obtaining period so as to obtain the environmental data from the sensor control device 34.

According to the present embodiment, the management device 50-1 can manage the sensor control device 34 in an appropriate manner and can notify the user in a case where the environmental data satisfied a predetermined condition or a case where the management device 50-1 cannot communicate with the sensor control device 34 normally.

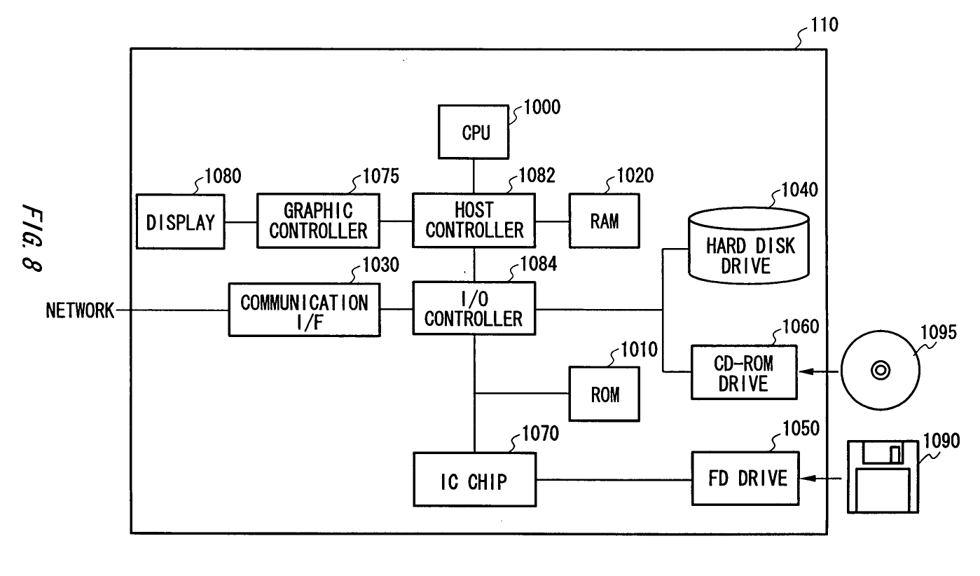

FIG. 8 shows an exemplary hardware configuration of a personal computer 110 as an exemplary management device 50-1 according to the present embodiment. The personal computer 110 of the present embodiment includes: a CPU peripheral part having a CPU 1000, a RAM 1020, a graphic controller 1075, and a display 1080 that are mutually connected by a host controller 1082; an input/output part having a communication interface 1030, a hard disk drive 1040 and a CD-ROM drive 1060 that are connected to the host controller 1082 by an input/output controller 1084; and a legacy input/output part having a ROM 1010, a flexible disk drive 1050 and an input/output chip 1070 that are connected to the input/output controller 1084.

The host controller 1082 connects the RAM 1020 to the CPU 1000 and the graphic controller 1075 that access the RAM 1020 at a high transfer rate. The CPU 1000 operates based on a program stored in the ROM 1010 and the RAM 1020 so as to control the respective parts. The CPU 1000 may operate as the SNMP management unit 52 and the notification unit 56 (see FIG. 1). The graphic controller 1075 obtains image data that the CPU 1000 or the like generates in a flame buffer provided in the RAM 1020, and displays the obtained image data on the display 1080. Instead, the graphic controller 1075 may include a flame buffer for storing the image data that the CPU 1000 or the like generates.

The input/output controller 1084 connects the host controller 1082 to the communication interface 1030, the hard disk drive 1040 and the CD-ROM drive 1060 that are relatively high-speed input/output device. The communication interface 1030 communicates with another device via a network. The hard disk drive 1040 stores a program and data used by the personal computer 110. The hard disk drive 1040 may operate as the browsed data storing unit 54 and the contact information database 58 (see FIG. 1). The CD-ROM drive 1060 reads a program or data from a CD-ROM 1095 and provides it to the input/output chip 1070 via the RAM 1020.

Moreover, to the input/output controller 1084, the ROM 1010 and a relatively low-speed input/output device such as the flexible disk drive 1050 and the input/output chip 1070 are connected. The ROM 1010 stores a boot program that is executed by the CPU 1000 at the startup of the personal computer 110, a program depending on the hardware of the personal computer 110 and the like. The flexible disk drive 1050 reads a program or data from a flexible disk 1090 and provides it to the input/output chip 1070 via the RAM 1020. The input/output chip 1070 connects with the flexible disk 1090 or various types of input/output device via a parallel port, a serial port, a keyboard port or a mouse port, for example.

In the present embodiment, the program stored in the RAM 1020 includes an SNMP management module, a notification module, a browsed data storage module and a contact information data module. These modules make the personal computer 110 operate as the SNMP management unit 52, the notification unit 56, the browsed data storage unit 54 and the contact information database 58.

The program or module described above may be stored in an external storage medium. As the storage medium, other than the flexible disk 1090 and the CD-ROM 1095, an optical recording medium such as a DVD or PD, a magneto-optical recording medium such as an MD, a tape medium, a semiconductor memory such as an IC card and the like can be used.

As described above, according to the present embodiment, a management system that can manage a device to be managed that does not have an IP network connection function in accordance with SNMP can be provided at a low cost. Thus, it is possible to provide a proxy agent that can be used in a desired environment.

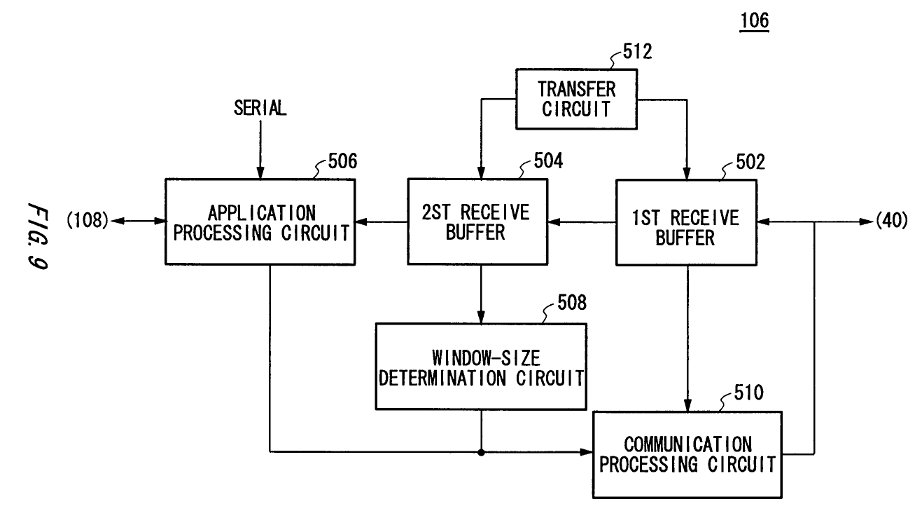

FIG. 9 shows an exemplary detailed structure of the SNMP control unit 106. The SNMP control unit 106 of the present embodiment realizes precise flow control with a small buffer capacity.

The SNMP control unit 106 includes the first receive buffer 502, a communication processing circuit 510, a transfer circuit 512, the second receive buffer 504, an application processing circuit 506 and a window-size determination unit 508.

The first receive buffer 502 is a ring buffer that stores an IP packet received from the communication network 40. The IP packet is a packet based on IP (Internet Protocol) and contains a packet header and packet data.

The packet header contains an IP header that is a header based on IP and a transport header that is a header of a transport layer. The transport header is a TCP header based on TCP (Transmission Control Protocol) or a UDP header based on UDP (User Datagram Protocol), for example. The packet data is data of the transport layer such as TCP or UDP, for example.

In the present embodiment, the first receive buffer 502 stores the packet header as an example of the first partial data that is a part of the IP packet, and also stores the packet data as an example of the second partial data that is a part of the IP packet different from the first partial data. Alternatively, the first receive buffer 502 may store the first partial data and the second partial data that are partially overlapped. For example, the first receive buffer 502 may store the IP packet as the first partial data and the packet data as the second partial data.

The communication processing circuit 510 takes the packet header from the first receive buffer 502 one by one and performs IP protocol processing and transport protocol processing that are examples of header processing based on the packet header. The IP protocol processing and the transport protocol processing are header processing based on the IP header and header processing based on the transport header, respectively, and are examples of the first processing performed by the SNMP control unit 106.

In the present embodiment, the communication processing circuit 510 has a function of realizing TCP/IP protocol stack. The communication processing circuit 510 may perform TCP/IP protocol stack processing by hardware processing. In this case, the communication processing circuit 510 can perform IP protocol processing and transport protocol processing at a high speed.

The transfer circuit 512 extracts the packet data from the IP packet based on a value in a packet-length field contained in the IP header and a value in a data-offset field contained in the TCP header, for example. The transfer circuit 512 then transfers the extracted packet data from the first receive buffer 502 to the second receive buffer 504, for example, in synchronization with receiving of the IP packet by the first receive buffer 502, for example.

The second receive buffer 504 is a ring buffer that receive and stores the packet data transferred by the transfer circuit 512. The second receive buffer 504 receives the packet data from the first receive buffer 502 in such a manner that at least a part of that receiving is performed in parallel with at least a part of either IP protocol processing or transport protocol processing.

The application processing circuit 506 receives the packet data stored in the second receive buffer 504, for example, as stream data in a first-in first-out order and performs processing based on SNMP (SNMP processing). The application processing circuit 506 updates MIB stored in the MIB storage unit 108 by SNMP processing. Moreover, the application processing circuit 506 may perform SNMP processing in accordance with an instruction received from the outside via a serial interface.

The above-described SNMP processing is an example of processing of the application layer, that is performed for the packet data, and is an example of the second processing that requires a longer processing time than that the first processing. The communication processing circuit 510 performs header processing at a higher speed than the SNMP processing by the application processing circuit 506. Alternatively, the application processing circuit 506 may receive the packet data based on HTTP, a multimedia call control protocol or a TELNET protocol for example, so as to update MIB based on the received packet data.

The window-size determination circuit 508 determines a window size in TCP based on the available capacity of the second receive buffer 504 in a case where the IP packet the first receive buffer 502 received is a packet based on TCP. The window-size determination circuit 508 then notifies the communication processing circuit 510 of the determined window size. The communication processing circuit 510 then notifies a sender of the IP packet of that window size via the communication network 40.

In the present embodiment, the first receive buffer 502 transfers the packet data contained in the IP packet to the second receive buffer 504 by parallel processing that is synchronized with the reception of that IP packet. The communication processing circuit 510 then processes the packet header stored in the first receive buffer 502 at a higher speed than that of the SNMP processing performed by the application processing circuit 506.

In this manner, the first receive buffer 502 can receive the next IP packet before completion of the application processing performed for the received IP packet. Therefore, according to the present embodiment, the capacity of the buffer for receiving the IP packet can be reduced. The capacity of the first receive buffer 502 may be as large as the maximum size of the received IP packet, for example. In addition, according to the present embodiment, it is possible to efficiently process the IP packet with a low buffer capacity.

Moreover, in the present embodiment, the first receive buffer 502 and the second receive buffer 504 are ring buffers. In this case, if the first receive buffer 502 or the second receive buffer 504 stores data in a part thereof, the remaining part can be effectively used as the available capacity. Therefore, according to the present embodiment, even in a case where the capacity of the first or second receive buffer 502 or 504 is small, data transfer can be preformed in an appropriate manner. Thus, it is possible to provide the sensor control device 34 (see FIG. 1) at a low cost.

In the present embodiment, the SNMP control unit 106 divides the received IP packet into the packet header and the packet data and then processes the packet header and the packet data separately. The communication processing circuit 510 may generate a new packet header based on the received packet header and may generate a new IP packet based on that new packet header and the packet data stored in the second receive buffer 504, for example.

The communication processing circuit 510 may transmit the new IP packet thus generated to the communication network 40 or another network such as a private network. In this manner, the SNMP control unit 106 can relay the IP packet with the packet header changed. In this case, it is possible to relay the IP packet securely.

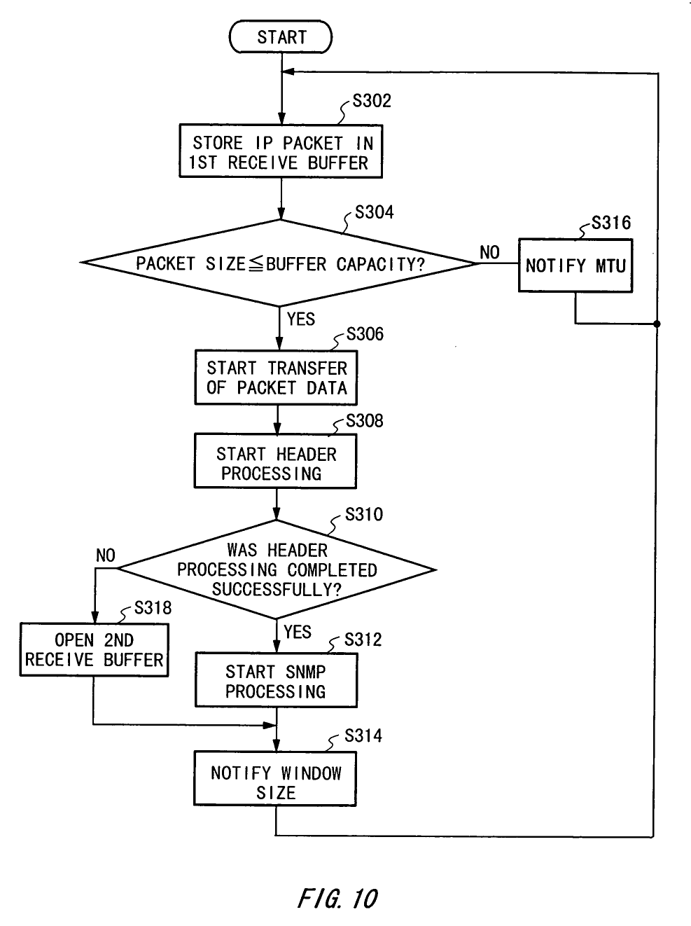

FIG. 10 is a flowchart of an exemplary operation of the SNMP control unit 106. First, the first receive buffer 502 stores an IP packet received from the communication network 40 (Step S302). When the data size of the received IP packet is smaller than the capacity of the first receive buffer 502 (Step S304), the transfer circuit 512 starts transfer of the packet data to the second receive buffer 504 (Step S306) and the communication processing circuit 510 starts header processing based on the packet header (Step S308).

In a case where the header processing was completed successfully (Step S310), the application processing circuit 506 starts SNMP processing of the packet data stored in the second receive buffer 504 (Step S312). In this case, the first receive buffer 502 may open a region in which the IP packet was stored.

Then, the communication processing circuit 510 notifies the sender of the IP packet of the window size determined by the window-size determination circuit 508 (Step S314). Then, the operation returns to Step S302 where the communication processing circuit 510 receives the next IP packet and stores therein. In this case, the first receive buffer 502 may receive the next IP packet during the SNMP processing performed by the application processing circuit 506.

In a case where the received IP packet has a larger data size than the capacity of the first receive buffer 502 in Step S304, the communication processing circuit 510 notifies the sender of the IP packet of the capacity of the first receive buffer 502 as the maximum transfer unit (MTU) (Step S316).

Moreover, in a case where the header processing was not completed successfully in Step S310, the second receive buffer 504 opens a region that stores the packet data corresponding to the packet header for which the header processing was not completed successfully (Step S318) and the operation goes to Step S314. In this case, it is preferable that the communication processing circuit 510 perform failure processing based on the result of unsuccessful completion.

In the present embodiment, the communication processing circuit 510 receives another IP packet after transferring the packet data to the second receive buffer 504. Therefore, according to the present embodiment, it is possible to efficiently receive IP packets with a small buffer capacity. Moreover, the window-size determination circuit 508 determines an appropriate window size corresponding to the receivable data size based on the available capacity of the second receive buffer 504. Therefore, according to the present embodiment, it is possible to prevent retransmission of IP packet caused by the wrong window size. It is also possible to realize precise flow control.

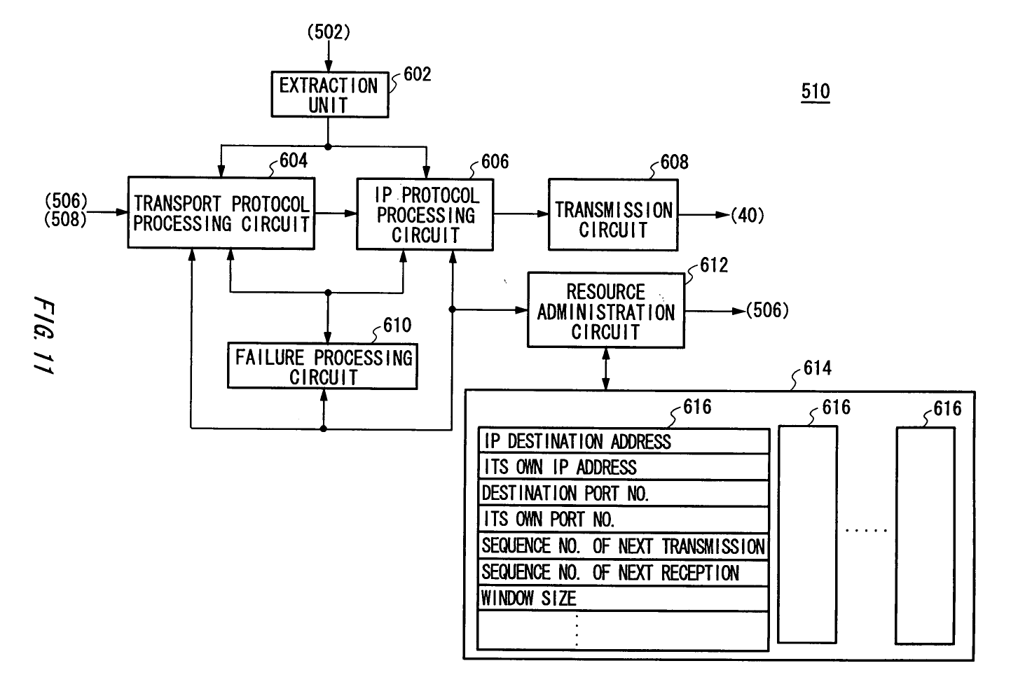

FIG. 11 shows an example of the detailed structure of the communication processing circuit 510. In the present embodiment, the communication processing circuit 510 performs IP protocol processing and transport protocol processing at a high speed. The communication processing circuit 510 includes an extraction circuit 602, an IP protocol processing circuit 606, a transport protocol processing circuit 604, a session information storage circuit 614, a resource administration circuit 610 and a transmission circuit 608.

The extraction circuit 602 extracts an IP header and a transport header from an IP packet received by the first receive buffer 502 and supplies the IP header and the transport header thus extracted to the IP protocol processing circuit 606 and the transport processing circuit 604, respectively. In this extraction, the extraction circuit 602 extracts the IP header based on a value in an IHL (Internet Header Length) field contained in the IP packet.

In a case where the IP packet contains a TCP header that is an example of the transport header, the extraction circuit 602 extracts the TCP header from the IP packet based on a value of a portion of the TCP header at which a dada-offset field is to be positioned and a value in the IHL field. In a case where the IP packet contains a UDP header that is an example of the transport header, the extraction circuit 602 extracts the UDP header from the IP packet based on a value of a portion of the UDP header at which a UDP header length is to be positioned and the value in the IHL field.

The IP protocol processing circuit 606 performs IP protocol processing based on the IP header extracted by the extraction circuit 602. The IP protocol processing circuit 606 may perform IP protocol processing by hardware processing. In this case, the IP protocol processing circuit 606 can perform the IP protocol processing at a high speed.

The IP protocol processing circuit 606 detects a failure in the IP protocol processing in a predetermined case. For example, the IP protocol processing circuit 606 may detect the failure in the IP protocol processing in a case where the version number of the IP header is a number other than numbers that are predetermined and is not supported, or a case where the number indicating the service type of the IP header is not a predetermined number that is acceptable. Moreover, the IP protocol processing circuit 606 may detect the failure in the IP protocol processing in a case where the checksum value of the IP header that was recalculated is different from the number stored in a header-checksum field of the IP header.

The transport protocol processing circuit 604 performs TCP protocol processing or UDP protocol processing that is an example of transport protocol processing, based on the transport header extracted by the extraction circuit 602. In the present embodiment, the transport protocol processing circuit 604 performs the transport protocol processing in such a manner that at least a part of the transport protocol processing is performed in parallel with the IP protocol processing by the IP protocol processing circuit 606, for example, by hardware processing. Therefore, the transport protocol processing circuit 604 can perform transport protocol processing at a high speed.

The transport protocol processing circuit 604 detects a failure in the transport protocol processing in a predetermined case. For example, the transport protocol processing circuit 604 may detect the failure in a case where a trouble occurs in window control of the IP packet. In other words, the transport protocol processing circuit 604 may detect the failure in a case where it received an IP packet that contains a TCP header having a sequence number out of the specified receive window.

Moreover, the transport protocol processing circuit 604 may detect the failure in the transport protocol processing in a case where it received data that was already received again. In other words, the transport protocol processing circuit 604 may detect the failure in a case where replication of the IP packet occurs in the network or a case where ACK did not reach the sender of the IP packet, for example. Furthermore, the transport protocol processing circuit 604 may detect the failure in a case where it further received an IP packet after receiving FIN.

The session information storage unit 614 is a memory for storing session information indicating a session that was established between the communication processing circuit 510 and a communication device connected to the communication network 40. The session information storage unit 614 dynamically generates a PCB (Protocol Control Block) 616 every time a session between the communication processing circuit 510 and an external communication device was established and stores the session information. Thus, the session information storage unit 614 stores a plurality of PCBs 616 the number of which is equal to the number of the established sessions. Each PCB 616 stores, for the corresponding session, information indicating an IP address of the other end of the session and its own IP address, a port number of the other end of the session and its own port number, a sequence number of a TCP packet to be sent next, a sequence number of a TCP packet to be received next and a window-size advised by the other end of the session.

The resource administration circuit 612 obtains the information stored in the PCB 616 from the session information storage unit 614 and supplies the obtained information to the IP protocol processing circuit 606, the transport protocol processing circuit 604 and the failure processing circuit 610. Moreover, the resource administration circuit 612 notifies the application processing circuit 506 of the result of IP protocol processing by the IP protocol processing circuit 606 and the result of transport protocol processing by the transport protocol processing circuit 604. The application processing circuit 506 may perform SNMP processing based on those results.

The resource administration circuit 612 administrates the session based on the PCB dynamically generated in accordance with the establishment of that session. Therefore, according to the present embodiment, the communication processing circuit 510 can have a function of a terminal that performs communication by a single session, a function of accumulating a plurality of sessions and performing multiple communications or a function of relaying communication based on a plurality of sessions.

The resource administration circuit 612 may perform the administration of session by hardware processing. In this case, the resource administration circuit 612 can perform resource administration of the communication processing circuit 510 at high speed. The resource administration circuit 612 may perform scheduling of processing the sessions by administrating hardware resource of the IP protocol processing circuit 606, transport protocol processing circuit 604, failure processing circuit 610 or the like.

The failure processing circuit 610 performs failure processing in case where the IP protocol processing circuit 606 detected a failure in IP protocol processing or a case where the transport protocol processing circuit 604 detected a failure in transport protocol processing. The failure processing circuit 610 may transmit a request for retransmission of an IP packet or issue a notification of a communication error to the sender of that IP packet as the failure processing, for example.

The failure processing circuit 610 may detect the failure based on the result of the IP protocol processing by the IP protocol processing circuit 606 and the result of the transport protocol processing by the transport protocol processing circuit 604. In this case, the failure processing circuit 610 may detect the failure based on the session information stored in the session information storage unit 614.

The failure processing circuit 610 may detect the failure when the IP packet received from the communication network 40 does not request establishment of a session and session information, that indicates a session specified by the sender and destination IP addresses contained in the IP header of the IP packet and the sender and destination port numbers contained in the transport header of the IP packet, is not stored in the session information storage unit 614. In addition, the failure processing circuit 610 may detect the failure in a case where a port indicated by the destination port number of the TCP packet is not in a available state (Listen State) or a case where the sender IP address in the IP header of the IP packet that requests establishment of a session indicates an IP address at which no service is allowed.

The transmission circuit 608 transmits the IP packet to the communication network 40. More specifically, the transmission circuit 608 transmits the IP packet based on the data generated by the application processing circuit 506, the window size determined by the window-size determination circuit 508 or the result of the failure processing by the failure processing circuit 610, for example.

In this case, the transport protocol processing circuit 604 receives the data generated by the application processing circuit 506 or the window size determined by the window-size determination circuit 508 and then generates a TCP packet by TCP protocol processing based on the data or window size thus received. The IP protocol processing circuit then receives that TCP packet from the transport protocol processing circuit 604, generates an IP packet by IP protocol processing and transmits the generated IP packet to the transmission circuit 608. The transmission circuit 608 transmits the received IP packet to the communication network 40.

In the present embodiment, the communication processing circuit 510 performs IP protocol processing and transport protocol processing for the received IP packet in such a manner that at least a part of the IP protocol processing is performed in parallel with at least a part of the transport protocol processing. Therefore, according to the present embodiment, it is possible to process the IP packet at a high speed. Thus, even if the capacity of the first receive buffer 502 is small, the IP packet can be processed in an appropriate manner.

In this case, the application processing circuit 506 may perform application protocol processing based on transport protocol. For example, the application processing circuit 506 may perform processing based on HTTP, a multimedia call control protocol or a TELNET protocol, that is an example of the application protocol based on TCP. Moreover, the application processing circuit 506 may perform a multimedia control protocol based on UDP. In this case, it is preferable that the transport protocol processing circuit 604 perform flow control in an upper layer such as RTP, for example.

Here, a case is considered where application protocol processing is performed by using a small-scale CPU and a small-capacity memory. In this case, the processing may require much time. For example, if a Web application based on HTTP or an application based on a multimedia call control protocol is executed, HTMP processing, drawing or the like requires much time. However, according to the present embodiment, by performing processing of the received IP packet at a high speed, the above-described processing can be performed efficiently at a high speed. Therefore, according to the present embodiment, a terminal that executes the above-described application can be provided at a low cost.

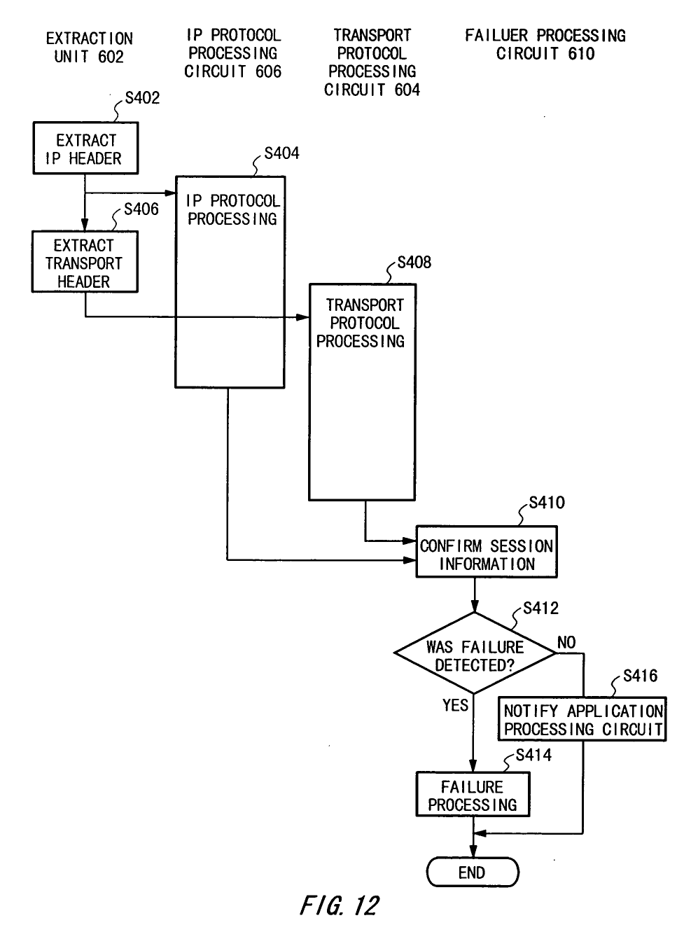

FIG. 12 is a flowchart of an exemplary operation of the communication processing circuit 510 for processing the received IP packet. First, the extraction circuit 602 extracts an IP header from an IP packet (Step S402), and the IP protocol processing circuit 606 starts IP processing based on the extracted IP header (Step S404). The extraction circuit 602 then extracts a transport header (Step S406), and the transport protocol processing circuit 604 starts transport protocol processing based on the extracted transport header (Step S408). In this manner, the transport processing circuit 604 performs the transport protocol processing in such a manner that at least a part of the transport protocol processing is performed in parallel with at least a part of the IP protocol processing.

Then, the failure processing circuit 610 confirms session information based on the results of the IP protocol processing and transport protocol processing (Step S410). When the IP protocol processing circuit 606, transport protocol processing circuit 604 or failure processing circuit 610 detected a failure (Step S412), the failure processing circuit 610 performs processing of that failure (Step S414) and the communication processing circuit 510 completes processing of the IP packet.

On the other hand, when no failure was detected in Step S412, the resource administration circuit 612 notifies the application processing circuit 506 of the result of the IP protocol processing by the IP protocol processing circuit 606 and the result of the transport protocol processing by the transport protocol processing circuit 604, thereby causing the application processing circuit 506 to start SNMP processing (Step S416), and the communication processing circuit 510 completes processing of the IP packet. According to the present embodiment, the communication processing circuit 510 can perform IP protocol processing and transport protocol processing in parallel in an appropriate manner.

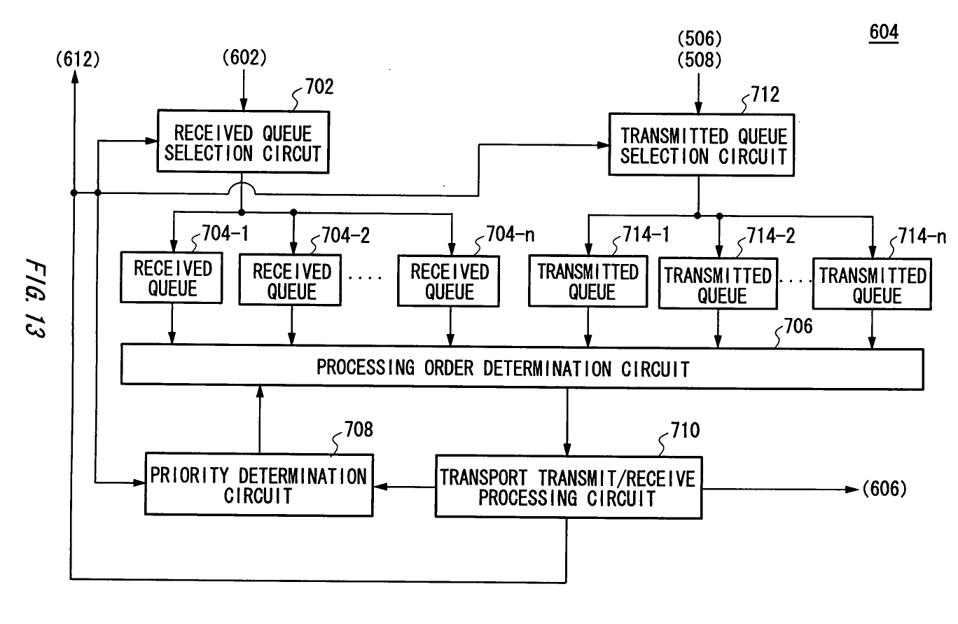

FIG. 13 shows an exemplary detailed structure of the transport protocol processing circuit 604. The transport protocol processing circuit 604 of the present embodiment changes an order of processing IP packets received from the communication network 40 (See FIG. 11) in accordance with priorities of those IP packets. The transport protocol processing circuit 604 includes a received queue selection circuit 702, a plurality of received queues 704-1 . . . 704-n, a transmitted queue selection circuit 712, a plurality of transmitted queue 714-1 . . . 714-n, a priority determination circuit 708, a processing order determination circuit 706 and a transport transmit/receive processing circuit 710.

The received queue selection circuit 702 receives a transport header as an exemplary received packet from the extraction circuit 602 and selects one received queue 704 based on the received transport header. In this case, the received queue selection circuit 702 identifies a session corresponding to the IP packet based on the transport header and selects the received queue 704 based on that session, for example. The received queue selection circuit 702 may receive information indicating that session from the session information storage unit 614 (see FIG. 11) via the resource administration circuit 612. The received queue selection circuit 702 makes the selected received queue 704 store the transport header therein.

The received queue selection circuit 702 may make the selected received queue 704 further store data in a transport layer. In this case, the received queue 704 may store a TCP packet or a UDP packet.

The transmitted queue selection circuit 712 receives data generated by the application processing circuit 506 or a window size determined by the window-size determination circuit 508 as a transmitted packet, and makes one transmitted queue 714 store the transmitted packet therein. The transmitted queue selection circuit 712 may select one transmitted queue 714 in accordance with the destination of the transmitted packet, for example. In this case, the transmitted queue selection circuit 712 may receive information indicating that destination from the session information storage unit 614.

The priority determination circuit 708 determines, based on the transport header, the priority of the received queue 704 storing that transport header. In the present embodiment, the priority determination circuit 708 determines the priority based on information indicating the session corresponding to that transport header. In a case where the transport header is a TCP header, the priority determination circuit 708 may determine the priority based on a code bit such as SYN or FIN, or a destination port number as an application identifier, that is contained in the TCP header, for example.

Alternatively, the priority determination circuit 708 may receive information indicating a sender address contained in an IP header from the IP protocol processing circuit 606 (See FIG. 11) so as to determine the priority based that information. Moreover, the priority determination circuit 708 determines the priority for each of a plurality of transmitted queues 714 based on information indicating a session corresponding to the transmitted packet stored in that transmitted queue 714.

The processing order determination circuit 706 determines a processing order in which transport protocol is to be performed for the transport headers stored in a plurality of received queues 704-1 . . . 704-n based on the priorities of the respective received queues 704. Moreover, in the present embodiment, the processing order determination circuit 706 determines the processing order in which transport protocol processing is to be performed for the transport headers stored in the received queues 704 and the transmitted packets stored in the transmitted queues 714 further based on the priorities of the transmitted queues 714.

The transport transmit/receive processing circuit 710 performs transport protocol processing for the transport header stored in the received header 704 and then outputs the result of the processing to the resource administration circuit 612. In this case, the resource administration circuit 612 may access the session information storage unit 614 so as to update the PCB 616 (see FIG. 11) that corresponds to that transport header.

The transport transmit/receive processing circuit 710 also performs transport protocol processing for the transmitted packet stored in the transmitted queue 714 and then supplies that transmitted packet to the IP protocol processing circuit 606. In this case, the IP protocol processing circuit 606 may perform IP protocol processing for that transmitted packet further and may supply it to the transmission circuit 608 (see FIG. 11). The transmission circuit 608 may transmit the transmitted packet thus received to the communication network 40. According to the present embodiment, it is possible to appropriately process the received IP packets and the packets to be transmitted to the communication network 40 in accordance with the priorities.

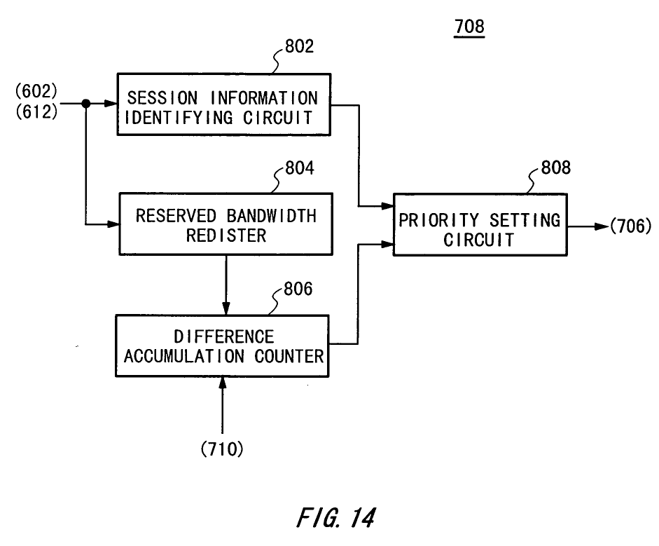

FIG. 14 shows an exemplary detailed structure of the priority determination circuit 708. In the present embodiment, the priority determination circuit 708 determines the priority of each of a plurality of received queues 704 (see FIG. 13) further based on the bandwidth that was set in advance for that received queue 704. The priority determination circuit 708 includes a session information identifying circuit 802, a reserved bandwidth register 804, a difference accumulation counter 806 and a priority setting circuit 808.

The session information identifying circuit 802 obtains information indicating a session corresponding to a transport header stored in each of a plurality of received queues 704 from the session information storage unit 614 via the resource administration circuit 612. As the information indicating the session, the session identifying circuit 802 may obtain the IP address and the port number of the other end of that session and its own IP address and port number, for example.

The reserved bandwidth register 804 stores the amount of processed IP packet per unit time, that was assigned to each received queue 704, as a reserved bandwidth therein. The reserved bandwidth register 804 may store the reserved bandwidth based on an instruction from the resource administration circuit 612.

The difference accumulation counter 806 stores a difference between a value of time integration of the reserved bandwidth and the accumulated processed amount, that corresponds to each received queue 704. The accumulated processed amount means the accumulated data amount of the processed IP packet corresponding to the transport header stored in that received queue 704.

In the present embodiment, the difference accumulation counter 806 adds a value that is stored to correspond to each received queue 704 and a value of the reserved bandwidth of that received queue 704 every time the unit time has passed. In a case where the result of the addition is equal to or larger than the value of the reserved bandwidth, the difference accumulation counter may store the value of the reserved bandwidth.

Every time the transport transmit/receive processing circuit 710 (see FIG. 13) processed a transport header, the difference accumulation counter 806 subtracts the data length of the IP packet corresponding to that transport header from the value stored therein. Thus, the difference accumulation counter 806 stores the difference between the accumulated processed amount and the time integration value of the reserved bandwidth. In a case where the subtraction result is equal to or smaller than a predetermined lower limit value, the difference accumulation counter 806 may store that lower limit value. In a case where the accumulated processed amount is larger than the time-integral value of the reserved bandwidth, the difference accumulation counter 806 may store a negative value.

The priority setting circuit 808 sets the priority for each of a plurality of received queues 704 based on information indicating the session identified by the session information identifying circuit 802 and the value stored in the difference accumulation counter 806. The priority setting circuit 808 may set the priority of the received queue 704 for which the difference accumulation counter 806 stores a larger value to be higher. The priority setting circuit 808 notifies the processing order determination circuit 706 of the priority thus set. According to the present embodiment, it is possible to appropriately set the priority for each of the received queues 704.

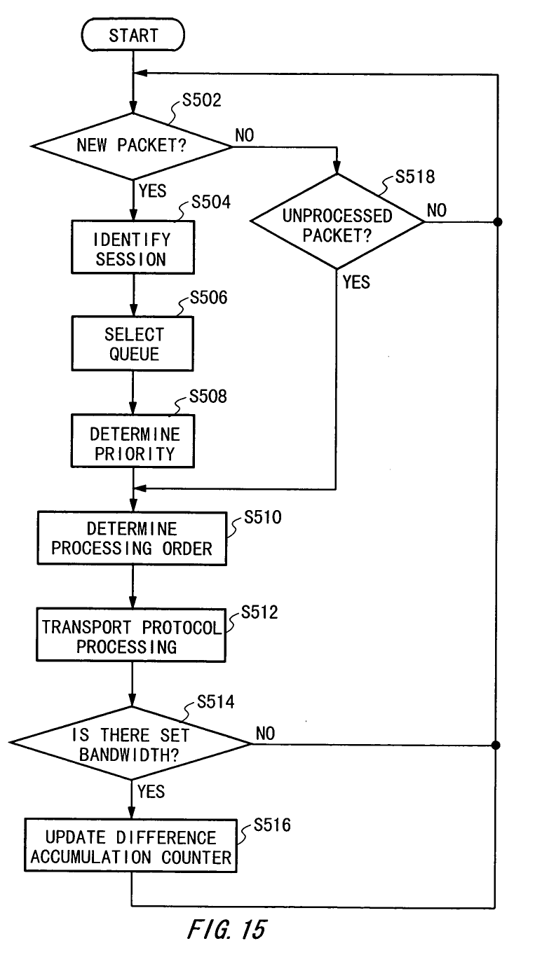

FIG. 15 is a flowchart of an exemplary operation of the transport protocol processing circuit 604. In a case where the received queue selection circuit 702 received a transport header as a new received packet (Step S502), the received queue selection circuit 702 identifies a session corresponding to that received packet (Step S504). The received queue selection circuit 702 then selects one received queue 704 and makes the received queue 704 thus selected store that received packet (Step S506). The priority determination circuit 708 determines the priority of that received queue 704 (Step S508).

In a case where the transmitted queue selection circuit 712 received a received packet that was newly generated in Step S502, the transmitted queue selection circuit 712 identifies a session corresponding to the transmitted packet thus received (Step S504). The transmitted queue selection circuit 712 then selects one transmitted queue 714 and makes the transmitted queue thus selected store that transmitted packet (Step S506). The priority determination circuit 708 determines the priority of that transmitted queue 714 (Step S508).

Next, the processing order determination circuit 706 determines the order in which the received packets and the transmitted packets that are stored in a plurality of received queues 704-1 . . . 704-n and a plurality of transmitted queues 714-1 . . . 714-n are to be processed, in accordance with the priorities of the received queues 704-1 . . . 704-n and the transmitted queues 714-1 . . . 714-n (Step S510). In the present embodiment, the processing order determination circuit 706 selects one received or transmitted queue 704 or 714 to be processed next. The transport transmit/receive processing circuit 710 then performs processing for the received packet stored in the received queue 704 or the transmitted packet stored in the transmitted queue 714 that was selected by the processing order determination circuit 706 (Step S512).

In a case where each of a plurality of received queues 704-1 . . . 704-n and a plurality of transmitted queues 714-1 . . . 714-n has a bandwidth that was set in advance (Step S514), the transport transmit/receive processing circuit 710 updates the value stored in the difference accumulation counter 806 (Step S516) and the operation goes back to Step S502.

In a case where the received queue selection circuit 702 received no new received packet and the transmitted queue selection circuit 712 received no new transmitted packet (Step S502) and any of the received queues 704 or transmitted queues 714 stores a received or transmitted packet that has not been processed yet (Step S518), the processing order determination circuit 706 selects the next received queue 704 or transmitted queue 714 (Step S510).

Moreover, in a case where the received queue selection circuit 702 received a new received packet or the transmitted queue selection circuit 712 received a new transmitted packet (Step S502), the processing order determination circuit 706 determines a new processing order in accordance with Steps S504 to S508 (Step S510). In addition, in a case where there is no received or transmitted packet that has not been processed yet in Step S512, the operation goes back to Step S502 where the received queue selection circuit 702 or the transmitted queue selection circuit 712 waits for a new received or transmitted packet. According to the present embodiment, it is possible to sequentially process received packets respectively stored in a plurality of received queues 704-1 . . . 704-n and transmitted packets respectively stored in a plurality of transmitted queues 714-1 . . . 714-n in an appropriate processing order.

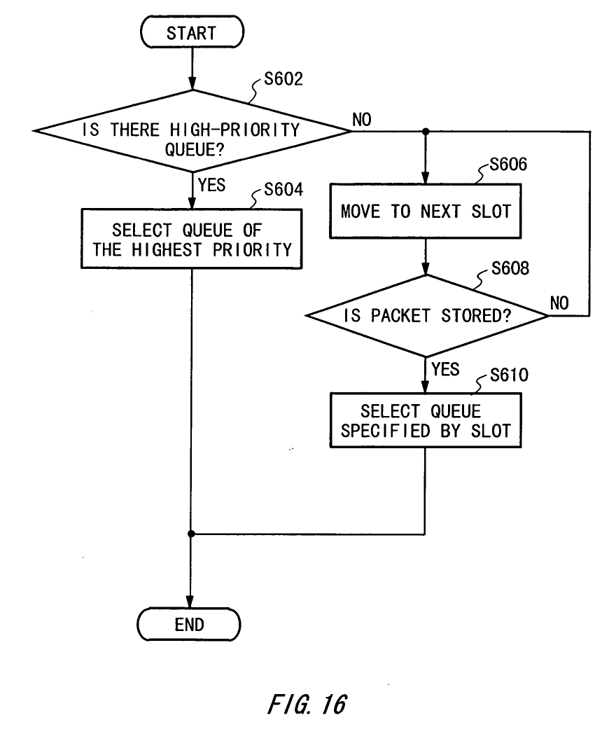

FIG. 16 is a flowchart of an exemplary operation of the processing order determination circuit 706. In the present embodiment, the processing order determination circuit 706 selects one received queue 704 or one transmitted queue 714 in accordance with a scheduling having a plurality of slots. Each of the slots specifies any of the received queues 704 or transmitted queues 714 based on a user's instruction, thereby specifying the processing order of the received queues 704 or the transmitted queues 714.

First, in a case where any of the received queues 704 storing received packets or the transmitted queues 714 storing transmitted packets has a higher priority than a predetermined priority (Step S602), the processing order determination circuit 706 selects that received queue 704 or transmitted queue 714 (Step S604) and the operation is finished. In a case where there are more than one received queues 704 and/or transmitted queues 714 having priorities higher than the predetermined priority, the processing order determination circuit 706 selects one of the received queues 704 and transmitted queues 714 that has the highest priority (Step S604).

Thus, the transport transmit/receive processing circuit 710 prioritizes processing for the received packet stored in the received queue 704 having the higher priority and processing for the transmitted packet stored in the transmitted queue 714 having the higher priority. Each of a plurality of received queues 704 may store a plurality of received packets and each of a plurality of transmitted queues 714 may store a plurality of transmitted packets. In this case, when the received queue 704 or the transmitted queue 714 that has the highest priority stores the received or transmitted packet, the processing order determination circuit 706 selects that received queue 704 or transmitted queue 714. Therefore, the transport transmit/receive processing circuit 710 processes the received or transmitted packets stored in the received queue 704 or the transmitted queue 714 that has the highest priority, and thereafter processes the received or transmitted packets stored in the received queue 704 or the transmitted queue 714 having the next priority

On the other hand, in a case where the received queue 704 having the higher priority stores no received packet and the transmitted queue 714 having the higher priority stores no transmitted packet (Step S602), the slot is set forward by one and the next slot of the scheduling is selected (Step S606).

When the received queue 704 or the transmitted queue 714 specified by the selected slot stores a received or transmitted packet (Step S608), the processing order determination circuit 706 selects that received queue 704 or transmitted queue 714 (Step S610) and the operation is finished. On the other hand, when the received queue 704 or the transmitted queue 714 corresponding to the selected slot stores no received or transmitted packet (Step S608), the slot is further set forward by one and the next slot is selected (Step S606) and the operation moves to Step S608.

In this manner, the processing order determination circuit 706 selects one of a plurality of received queues 704 one by one in accordance with an order that was set in advance in a plurality of slots. Moreover, after selecting the received queue 704 specified by one slot, the processing order determination circuit 706 sets the slot forward by one before selecting the next received queue 704. Thus, the processing order determination circuit 706 selects the next received queue 704 every time the transport transmit/receive processing circuit 710 processes the transport header.

In the present embodiment, the processing order determination circuit 706 prioritizes processing for the received packet stored in the received queue 704 and the transmitted packet stored in the transmitted queue 714 that have the higher priority than a predetermined priority, and then processes the received packets or transmitted packets stored in other received queues 704 or other transmitted queues 714 in accordance with the scheduling that was set in advance. Therefore, according to the present embodiment, while processing for the received queue 704 or transmitted queue 714 that has the higher priority is surely prioritized, it is possible to perform processing for other received queues 704 or transmitted queues 714 with no starvation in which queues having higher priorities are successively processed. Thus, according to the present embodiment, even in an application that processes a plurality of sessions simultaneously, such as a server-system application, those sessions can be efficiently processed.

In an alternative embodiment, the processing order determination circuit 706 may determine the order of transport protocol processing based on which received queue 704 or transmitted queue 714 stores the received packet or transmitted packet. In this case, in accordance with the session corresponding to the received packet, for example, the received queue selection circuit 702 may select the received queue 704 in which that received packet is to be stored. Moreover, the received queue selection circuit 702 may select a code bit or a destination port number contained in a TCP header, an example of the received packet, or one received queue 704 contained in an IP header which contains that transport header. Furthermore, the transmitted queue selection circuit 712 may select, in accordance with the session corresponding to the transmitted packet, one transmitted queue 714 in which that transmitted packet is to be stored, for example. In this case, the processing order determination circuit 706 can determine an appropriate processing order of the received packet or the transmitted packet.

Although the present invention has been described by way of exemplary embodiments, it should be understood that those skilled in the art might make many changes and substitutions without departing from the spirit and the scope of the present invention which is defined only by the appended claims.

### INDUSTRIAL APPLICABILITY

As is apparent from the above description, according to the present invention, it is possible to provide a management system for managing a device to be managed that does not have an IP network connection function at a low cost.

What is claimed is:

1. A semiconductor circuit device that is connected to a communication network, comprising:
a first receive buffer operable to store a packet received from said communication network;
a first processing circuit operable to perform first processing based on first partial data that is a part of said packet stored in said first receive buffer;
a second receive buffer operable to receive and store second partial data that is a part of said packet stored in said first receive buffer in parallel with said first processing at least partially, said second partial data being different from said first partial data; and
a second processing circuit operable to perform second processing based on said second partial data stored in said second receive buffer, said second processing requiring a longer processing time than said first processing.

2. A semiconductor circuit device as claimed in claim 1, further comprising a transfer circuit operable to transfer said second partial data from said first receive buffer to said second receive buffer, wherein
said first processing circuit performs said first processing after said transfer circuit started to transfer said second partial data.

3. A semiconductor circuit device as claimed in claim 1, wherein said first receive buffer stores a packet header and packet data of said packet,
said second receive buffer stores said packet data as second partial data,
said first processing circuit performs said first processing based on said packet header, and
said second processing circuit performs said second processing based on said packet data.

4. A semiconductor circuit device as claimed in claim 3, wherein said packet header contains an IP header and a transport header that is a header in a transport layer, and
said first processing circuit performs IP protocol processing and transport protocol processing based on said IP header and said transport header.

5. A semiconductor circuit device as claimed in claim 1, wherein said second receive buffer is a ring buffer.

6. A semiconductor circuit device as claimed in claim 1, further comprising:
a window-size determination circuit operable to determine a window size in TCP based on an available capacity of said second receive buffer in a case where said packet is a packet based on TCP; and
a window-size notification circuit operable to notify a sender of said packet of said window size.

7. A semiconductor circuit device as claimed in claim 1, wherein said second receive buffer stores said second partial data before said first receive buffer receives another packet next to said packet.

8. A semiconductor circuit device as claimed in claim 1, further comprising a transfer-unit notification circuit operable to notify a sender of said packet of a capacity of said first receive buffer as a maximum transfer unit when said first receive buffer received said packet having data amount larger than said capacity of said first receive buffer.

9. A packet processing method for processing a packet received from a communication network, comprising:
a first storing step of storing said received packet in a first receive buffer;
a first processing step of performing first processing based on first partial data that is a part of said packet stored in said first receive buffer;
a second storing step of transferring second partial data of said packet stored in said first receive buffer to a second receive buffer and storing said second partial data in said second receive buffer, at least partially in parallel with said first processing, said second partial data being different from said first partial data; and
a second processing step of performing second processing based on said second partial data stored in said second receive buffer, said second processing requiring a longer processing time than said first processing.

10. A semiconductor circuit device that is connected to a communication network, comprising:
an input unit operable to input an external input signal from a device to be managed outside said semiconductor circuit device;
an MIB storage unit operable to store input data indicating said external input signal input from said input unit in such a manner that said input data corresponds to an MIB (Management Information Base) object in SNMP (Simple Network Management Protocol); and
an SNMP control unit operable to transmit said input data that was made to correspond to said MIB object, to said communication network by using a message based on SNMP.

11. A semiconductor circuit device as claimed in claim 10, wherein said SNMP control unit manages an MIB object used for receiving a command for controlling said device to be managed from said communication network, and
a command output unit is further provided operable to, when said SNMP control unit received an SNMP message containing said command for said device to be managed from said communication network, give a command specified by said SNMP message to said device to be managed.

12. A semiconductor circuit device as claimed in claim 11, wherein, when said SNMP control unit received an SNMP message instructing said SNMP control unit to transmit a command for outputting said external input signal to said device to be managed,
said command output unit gives said command to said device to be managed,
said MIB storage unit stores said external input signal output in response to said command, as said input data, and
said SNMP control unit transmits said input data to said communication network by using a message based on SNMP.

13. A semiconductor circuit device as claimed in claim 11, wherein said MIB storage unit stores said input data in such a manner that said input data corresponds to an input-data MIB object that does not depend on a type of said device to be managed, and stores said command in such a manner that said command corresponds to a command MIB object that does not depend on said type of said device to be managed,
said SNMP control unit transmits said input data corresponding to said input-data MIB object to said communication network, and
said command output unit gives said command corresponding to said command MIB object to said device to be managed.

14. A semiconductor circuit device as claimed in claim 10, wherein said external input signal is an analog signal, and
an AD converter is further provided operable to generate said input data to be stored in said MIB storage unit by converting said analog signal into a digital signal.

15. A semiconductor circuit device as claimed in claim 10, wherein said MIB storage unit has an averaging time interval storage unit operable to store a time interval at which an average of a value of said external input signal is calculated in such a manner that said time interval corresponds to an MIB object, and
an average generation unit is further provided operable to generate said input data by calculating said average of said value of said external input signal at said time interval set in said averaging time interval storage unit.

16. A semiconductor circuit device as claimed in claim 15, wherein, when receiving an SNMP message instructing said SNMP control unit to set said averaging time interval storage unit from said communication network, said SNMP control unit sets said time interval specified by said SNMP message in said averaging time interval storage unit.

17. A semiconductor circuit device as claimed in claim 10, wherein said MIB storage unit has an input period storage unit operable to store a period with which a value of said external input signal is input in such a manner that said period corresponds to an MIB object, and
a data-storage control unit is further provided operable to make said MIB storage unit store said external input signal input from said input unit as said input data with said period set in said input period storage unit.

18. A semiconductor circuit device as claimed in claim 17, wherein, when receiving an SNMP message instructing said SNMP control unit to set said input period storage unit from said communication network, said SNMP control unit sets said period specified by said SNMP message in said input period storage unit.

19. A semiconductor circuit device as claimed in claim 10, wherein said MIB storage unit has a transmitting condition storage unit operable to store a condition for transmitting said input data to said communication network in such a manner that said condition corresponds to an MIB object, and
said SNMP control unit transmits said input data to said communication network by using a trap message based on SNMP in a case where said input data satisfies said condition set in said transmitting condition storage unit.

20. A semiconductor circuit device as claimed in claim 19, wherein said transmitting condition storage unit stores a threshold value of said input data as said condition, and
said SNMP control unit transmits said input data to said communication network in a case where a value of said input data exceeds said threshold value.

21. A semiconductor circuit device as claimed in claim 10, further comprising:
an encryption key storage unit operable to store a predetermined encryption key;
an IP address storage unit operable to store an IP address of a predetermined server; and
an encryption key acquisition unit operable to transmit an encryption key requesting message for requesting transmission of an encryption key to said server by using said IP address stored in said IP address storage unit to obtain a new encryption key, after start-up of said semiconductor circuit device, wherein
said SNMP control unit transmits said input data to said communication network by using a message encrypted by said new encryption key.

22. A semiconductor circuit device as claimed in claim 10, wherein said device to be managed is a sensor for detecting an outside environment,
said input unit inputs a value indicating said outside environment as said external input signal,
said MIB storage unit stores said external input signal input from said input unit as said input data, and
said SNMP control unit transmits said input data to said communication network by using a message based on SNMP.

23. A semiconductor circuit device as claimed in claim 22, wherein said sensor is one of a temperature sensor, a humidity sensor, a smoke sensor and a water sensor,
said input unit inputs a value indicating a temperature, a value indicating humidity, a value indicating presence and absence of smoke or a value indicating a water volume as said external input signal,
said MIB storage unit stores said external input signal input from said input unit as said input data, and
said SNMP control unit transmits said input data to said communication network by using a message based on SNMP.

24. A management system for detecting an outside environment, comprising:
a sensor operable to detect said outside environment; and
a semiconductor circuit device connected to said sensor and a communication network, wherein said semiconductor circuit device includes:
an input unit operable to input a value indicating said outside environment from said sensor as an external input signal;
an MIB storage unit operable to store input data indicating said external input signal input from said input unit in such a manner that said input data corresponds to an MIB (Management Information Base) object in SNMP (Simple Network Management Protocol); and
an SNMP control unit operable to transmit said input data corresponding to said MIB object to said communication network by using a message based on SNMP.

25. A management method for managing an outside device to be managed, comprising:
an input step of inputting an external input signal to a semiconductor circuit device connected to a communication network from said device to be managed;
an MIB storage step of storing input data indicating said external input signal that was input to said semiconductor circuit device in said input step in such a manner that said input data corresponds to an MIB (Management Information Base) object in SNMP (Simple Network Management Protocol); and
an SNMP transmission step of transmitting said input data corresponding to said MIB object to said communication network by using a message based on SNMP.

26. A semiconductor circuit device connected to a communication network, comprising:
a receiving circuit operable to receive an IP packet containing an IP header and a transport header that is a header in a transport layer, from said communication network;
an extraction circuit operable to extract said IP header and said transport header from said IP packet;
an IP protocol processing circuit operable to perform IP protocol processing based on said IP header extracted by said extraction circuit; and
a transport protocol processing circuit operable to perform transport protocol processing based on said transport header extracted by said extraction unit in such a manner that at least of a part of said transport protocol processing is performed in parallel with at least a part of said IP protocol processing.

27. A semiconductor circuit device as claimed in claim 26, wherein said extraction circuit extracts said IP header based on a value in an IHL (Internet Header Length) field contained in said IP packet, and, in a case where said IP packet contains a TCP header that is said transport header, extracts said TCP header from said IP packet based on a value in a portion of said TCP header at which a data-offset field is to be positioned and said value in said IHL field.

28. A semiconductor circuit device as claimed in claim 26, wherein said extraction circuit extracts said IP header based on a value in an IHL (Internet Header Length) field contained in said IP packet and, in a case where said IP packet contains a UDP header that is said transport header, extracts said UDP header from said IP packet based on a value in a portion of said UDP header at which a UDP header length is to be positioned and said value in said IHL field.

29. A semiconductor circuit device as claimed in claim 26, further comprising a failure processing circuit operable to perform failure processing in a case where said IP protocol processing circuit detected a failure in said IP protocol processing or in a case where said transport protocol processing circuit detected a failure in said transport protocol processing.

30. A semiconductor circuit device as claimed in claim 29, wherein said IP protocol processing circuit detects a failure in said IP protocol processing in a case where at least one of following conditions is satisfied: a version number of said IP header is different from a predetermined number; a checksum value of said IP header is different from a value stored in a header-checksum field of said IP header; and a value indicating a service type of said IP header is different from a predetermined value.

31. A semiconductor circuit device as claimed in claim 29, wherein said transport protocol processing circuit detects a failure in a case where data that was already received was received again or a case where a trouble occurs in window control of an IP packet.

32. A semiconductor circuit device as claimed in claim 29, further comprising a session information storage unit operable to store session information indicating a session established between said semiconductor circuit device and a communication device connected to said communication network, wherein
said failure processing circuit detects a failure in communication using said session corresponding to said session information stored in said session information storage unit.

33. A semiconductor circuit device as claimed in claim 32, wherein said failure processing circuit detects said failure in said communication using said session in a case where said IP packet received from said communication network does not request establishment of a session and a sender IP address and said session information storage unit does not store session information indicating a session specified by a destination IP address that are contained in said IP header of said IP packet and a sender port number and a destination port number contained in said transport header.

34. A packet processing method for processing an IP packet received from a communication network, comprising:
a receiving step of receiving an IP packet containing an IP header and a transport header that is a header in a transport layer from said communication network;
an extraction step of extracting said IP header and said transport header from said IP packet;
an IP protocol processing step of performing IP protocol processing based on said IP header extracted in said extraction step; and
a transport protocol processing step of performing transport protocol processing based on said transport header extracted in said extraction step in such a manner that at least a part of said transport protocol processing is performed in parallel with at least a part of said IP protocol processing.

35. A semiconductor circuit device connected to a communication network, comprising:
a plurality of received queues;
a received queue selection circuit operable to one of said plurality of received queues for each of a plurality of received packets received from said communication network based on a header of that received packet and to store that received packet in said selected one of said plurality of received queues; and
a processing order determination circuit operable to determine a processing order in which transport protocol processing is to be performed for each of said plurality of received packets stored in said plurality of received queues based on priorities of said plurality of received queues.

36. A semiconductor circuit device as claimed in claim 35, further comprising a priority determination circuit operable to determine, based on a header of said received packet, a priority of said received queue storing said received packet.

37. A semiconductor circuit device as claimed in claim 36, wherein said received queue selection circuit identifies a session corresponding to said received packet based on a header of said received packet and selects said one received queue that is to store said received packet based on said identified session, and
said priority determination circuit determines said priority based on said session corresponding to said received packet.

38. A semiconductor circuit device as claimed in claim 36, wherein said received queue selection circuit identifies a session corresponding to said received packet based on a header of said received packet and selects said one received queue that is to store said received packet based on said identified session, and
said priority determination circuit determines said priority based on said session corresponding to said received packet and a code bit contained in a TCP header of said received packet.

39. A semiconductor circuit device as claimed in claim 36, wherein said priority determination circuit determines said priority based on a destination port number contained in a TCP header of said received packet.

40. A semiconductor circuit device as claimed in claim 36, wherein said priority determination circuit determines said priority based on a sender address contained in an IP header corresponding to said received packet.

41. A semiconductor circuit device as claimed in claim 36, wherein said priority determination circuit determines said priority based on a bandwidth that was set in advance for each of said plurality of received queues.

42. A semiconductor circuit device as claimed in claim 35, further comprising a transport receiving processing circuit operable to perform transport protocol processing for said received packet, wherein
said plurality of received queues include at least one high-priority receive queue having high priority and a plurality of low-priority receive queues having lower priorities than said priority of said high-priority received queue,
in a case where said high-priority received queue stores said received packet, said transport receive processing circuit processes said received packet,
said processing order determination circuit selects one of said plurality of low-priority received queues one by one in said order that was set in advance every time said transport receive processing circuit processes said received packet stored in said low-priority received queue, and
in a case where said high-priority received queue stores no received packet, said transport receive processing circuit processes said received packet stored in said low-priority received queue selected by said processing order determination circuit.

43. A semiconductor circuit device as claimed in claim 35, wherein said received queue selection circuit selects said received queue that is to store said received packet based on at least one of a session corresponding to said received packet, a code bit contained in a TCP header of said received packet, a destination port number contained in said TCP header of said received packet and a sender address contained in an IP header of said received packet, and
said processing order determination circuit determines said processing order in which said transport protocol processing is to be performed based on which of said plurality of received queues each of said plurality of received packets is stored in.

44. A semiconductor circuit device as claimed in claim 35, further comprising a transmitted queue operable to store a transmitted packet that is to be transmitted to said communication network, wherein
said processing order determination circuit determines said processing order in which said transport protocol processing is to be performed for each of said plurality of received packets stored in said plurality of received queues and said transmitted packet stored in said transmitted queue, based on priorities of said plurality of received queues and a priority of said transmitted queue.

45. A packet processing method for processing a plurality of received packets that were received from a communication network, comprising:
a received queue selection step of selecting one of said plurality of received queues for each of said plurality of received packets based on a header of that received packet and storing that received packet in said selected one received queue; and
a processing order determination step of determining a processing order in which transport protocol processing is to be performed for each of said plurality of received packets stored in said plurality of received queues based on priorities of said plurality of received queues.

46. A management system for detecting an outside environment, comprising:
a sensor operable to detect said outside environment;
a semiconductor circuit device connected to said sensor and a communication network; and
a management device connected to said communication network, wherein
said semiconductor device includes an MIB storage unit operable to input input data indicating said outside environment from said sensor and store said input data in such a manner that said input data corresponds to an MIB (Management Information Base) object in SNMP (Simple Network Management Protocol), and
said management device includes:
a contact information database operable to store contact information of a user of said semiconductor circuit device in such a manner that said contact information corresponds to said semiconductor circuit device;
an SNMP management unit operable to obtain said input data from said semiconductor circuit device; and
a notification unit operable to obtain said contact information of said user of said semiconductor circuit device in a case where said input data satisfies a condition that was set in advance and notify said user that said input data satisfies said condition.

47. A management system as claimed in claim 46, wherein said SNMP management unit obtains said input data from said semiconductor circuit device with an obtaining period that was set in advance.

48. A management system as claimed in claim 46, wherein said SNMP management unit requests a response to said semiconductor circuit device with a response-requesting period that was set in advance, and
in a case where said semiconductor circuit device does not respond to said request, said notification unit obtains said contact information of said user of said semiconductor circuit device from said contact information database and notifies said user that said semiconductor circuit device does not respond.

49. A management system as claimed in claim 46, wherein said semiconductor circuit device further includes an SNMP control unit operable to, in a case where said input data satisfies said condition, transmit a trap message based on SNMP, indicating that said input data satisfies said condition, to said management device via said communication network,
said SNMP management unit obtains said trap message as said input data, and
said notification unit notifies said user that said input data satisfies said condition in a case where said SNMP management device obtained said trap message.

50. A management system as claimed in claim 49, wherein a plurality of management devices are provided,
said SNMP control unit confirms that communication with one of said plurality of management devices is available with a confirming period that was set in advance,
in a case where said communication with said one management device is available and said input data satisfies said condition that was set in advance, said SNMP control unit transmits said trap message indicating that said input data satisfies said condition to said one management device,
in a case where said communication with said one management device is not available, said SNMP control unit transmits a message indicating that said communication with said one management device is not available to another one of said plurality of management devices, and
in a case where said another management device received said message indicating that said communication with said one management device is not available, said notification unit of said another management device obtains said contact information of said user of said semiconductor device from said contact information database and notifies said user that said communication with said one management device is not available.

51. A management system as claimed in claim 49, said MIB storage unit includes a number-of-transmission storage unit operable to store a number of transmissions of said trap message to said management device in a case where said input data satisfies said condition that was set in advance, in such a manner that said number of transmissions corresponds to an MIB object,
said SNMP management unit sets said number of transmissions of said semiconductor circuit device by using a message based on SNMP, and
said SNMP control unit transmits said trap message to said management device a number of times in a case where said input data satisfies said condition that was set, said number of transmitted times being specified by said number of transmissions set by said management device.

52. A management system as claimed in claim 46, wherein said contact information database stores contact information of a mobile communication terminal, and
said notification unit obtains said contact information of said mobile communication terminal as said contact information of said user of said semiconductor circuit device and notifies said user that said input data satisfies said condition that was set in advance.

53. A management system as claimed in claim 52, wherein said management device further includes a browsed data storage unit operable to store said input data in such a manner that said input data is able to be browsed from said mobile communication terminal, in a case where said notification unit notified said user of said semiconductor circuit device.

54. A management system as claimed in claim 46, wherein said semiconductor circuit device further includes:
an input unit operable to input an analog value indicating said outside environment from said sensor; and
an AD conversion unit operable to convert said analog value into a digital value, wherein
said MIB storage unit stores said digital value as said input data.

55. A management system as claimed in claim 46, wherein said sensor is any one of a temperature sensor, a humidity sensor, a smoke sensor or a water sensor, and
said MIB storage unit inputs a value indicating a temperature, a value indicating humidity, a value indicating presence or absence or a value indicating a water volume as said input data in accordance with said sensor.
